(19) United States
(12) Patent Application Publication
(10) Pub. No.: US 2005/0068413 A1
(43) Pub. Date: Mar. 31, 2005

(54) Presensitized plate and lithographic printing method

(75) Inventors: Hisashi Hotta, Shizuoka (JP); Yoshinori Hotta, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/943,922

(22) Filed: Sep. 20, 2004

(30) Foreign Application Priority Data
Sep. 22, 2003 (JP) 2003-329951

(51) Int. Cl. B41J 2/435

(52) U.S. Cl. 347/264

(57) ABSTRACT

Disclosed is a presensitized plate, comprising: a support for a lithographic printing plate obtainable by forming on an aluminum plate at least an anodized layer, then performing sealing treatment; and an image recording layer which is provided on the support, includes an infrared absorber (A), a polymerization initiator (B), and a polymerizable compound (C), and can be removed with printing ink and/or dampening water. The presensitized plate of the present invention exhibits excellent on-machine developability, sensitivity, scumming resistance, chemical resistance and press life.

### BACKGROUND OF THE INVENTION

The present invention relates to a presensitized plate for lithographic printing, and to a lithographic printing method using the plate. More specifically, the invention relates to a presensitized plate which, by having an infrared laser scanned over it based on digital signals from a computer or the like, can be made directly into a lithographic printing plate, namely, by the direct platemaking, and relates also to a lithographic printing method in which the foregoing presensitized plate is developed and printed on a printing press.

Lithographic printing plates are generally composed of oleophilic image areas which are receptive to ink during the printing operation and hydrophilic non-image areas which are receptive to dampening water. Lithographic printing is a process that utilizes the mutual repellence between water and oil-based inks by having the oleophilic image areas of the printing plate serve as ink-receptive areas and having the hydrophilic non-image areas serve as dampening water-receptive areas (non-ink receptive areas), thus creating differences in the ability of ink to adhere to the surface of the plate and allowing the ink to be deposited only in the image areas. The ink that has been selectively deposited on the plate is then transferred to a printing substrate such as paper.

Presensitized plates composed of an oleophilic image recording layer on a hydrophilic support for a lithographic printing plate are widely used to make such lithographic printing plates. Generally, the lithographic printing plate is obtained by a platemaking process in which the presensitized plate is exposed to light through an original on lith film or the like, and next, the image recording layer is left intact in image areas but is dissolved and-removed with an alkaline developer or an organic solvent in non-image areas, thereby revealing the surface of the hydrophilic support.

Platemaking operations with prior-art presensitized plates have required, following light exposure, a step in which the non-image areas are dissolved and removed, typically with a developer or the like suitable for the image recording layer. One challenge has been how to simplify or eliminate altogether such wet processing carried out as an ancillary operation. The need for a solution to this problem is all the more acute because the treatment of wastewater discharged in connection with wet processing has become a major issue throughout the industrial world owing to concerns over the global environment.

One simple platemaking process that has been devised in response to the above need is referred to as “on-machine development.” This involves the use of an image recording layer which allows non-image areas of the presensitized plate to be removed in an ordinary printing operation. Following exposure of the presensitized plate to light, the non-image areas are removed on the printing press, yielding a lithographic printing plate.

Exemplary on-machine development methods include techniques that use a presensitized plate having an image recording layer which can be dissolved or dispersed in dampening water, ink solvent or an emulsion of dampening water and ink; techniques that mechanically remove the image recording layer by bringing it into contact with the impression cylinder or blanket cylinder on the printing press; and techniques in which cohesive forces within the image recording layer or adhesive forces between the image recording layer and the support are weakened by the penetration of, for example, dampening water or ink solvent, following which the image recording layer is mechanically removed by contact with the impression cylinder or blanket cylinder.

In this specification, unless noted otherwise, “processing step” refers to an operation in which, using an apparatus other than a printing press (typically an automated processor), unexposed areas of the image recording layer on the presensitized plate are brought into contact with a liquid (typically an alkaline developer) and removed, thereby revealing the surface of the hydrophilic support. “On-machine development” refers herein to a process and operation in which, using a printing press, unexposed areas of the image recording layer on the presensitized plate are brought into contact with a liquid (typically printing ink and/or dampening water) and removed, thus revealing the surface of the hydrophilic support.

In recent years, the use of digitizing technology to electronically process, store and output image information using computers has become very widespread, and various new image output systems adapted to such digitizing technology have come into use. Most notably, these trends have given rise to computer-to-plate (CTP) technology, in which digitized image data is carried on a highly convergent beam of radiation such as laser light which is scanned over a presensitized plate to expose it, thus enabling the direct production of a lithographic printing plate without relying on the use of lith film. One major technical challenge has been the development of presensitized plates suitable for CTP technology.

As already noted, the desire today for simpler platemaking operations which either involve dry processing or are process-free has grown increasingly acute, both on account of concerns over the global environment and for compatibility with digitization.

However, when a prior-art image recording technique that utilizes light in the ultraviolet to visible range is used to simplify the platemaking operations in on-machine development and the like, even after exposure to light, the image recording layer is not fixed and thus remains sensitive to indoor light. Therefore, once the presensitized plate has been removed from its packaging, it must be kept in a completely light-shielded state until on-machine development is complete.

Given the availability today of inexpensive high-output lasers such as semiconductor lasers and YAG lasers which emit infrared light at wavelengths of 760 to 1200 nm, techniques which employ these high-output lasers as the image recording light source show much promise as scanning exposure-based lithographic platemaking processes that can easily be integrated with digitizing technology.

In prior-art platemaking process that use ultraviolet to visible range light, the imagewise exposure of a photosensitive presensitized plate is carried out at a low to moderate illuminance, and the image is recorded by imagewise changes in physical properties brought about by photochemical reactions within the image recording layer.

By contrast, in methods that use the high-output lasers mentioned above, the region to be exposed is irradiated with a large amount of light for a very short period of time, the light energy is efficiently converted into thermal energy, and the heat triggers chemical changes, phase changes and changes in form or structure within the image recording layer, which changes are used to record the image. Thus, the image information is input by light energy such as laser light, but the image is recorded using both light energy and reactions triggered by thermal energy. Recording techniques which make use of heat generated by such high power density exposure are generally referred to as “heat mode recording,” and the conversion of light energy to heat energy is generally called “photothermal conversion.”The major advantages of platemaking methods that use heat mode recording are that the image recording layer is not sensitive to light at ordinary levels of illuminance such as indoor lighting, and that the image recorded with high-illuminance exposure does not need to be fixed. That is, prior to exposure the presensitized plates used in heat mode recording are not sensitive to indoor light, and following exposure the image does not-need to be fixed. Accordingly, there exists a desire for a printing system which uses an image recording layer that can be rendered insoluble or soluble by exposure to light such as from a high-power laser and in which, if the platemaking step where the exposed image recording layer is formed into an image to give a lithographic printing plate is carried out by on-machine development, following exposure, the image incurs no effects even when exposed to ambient indoor light.

JP 2002-287334 A (the term “JP XX-XXXXXX A” as used herein means an “unexamined published Japanese patent application”) describes, as a type of presensitized plate that combines such heat mode recording and on-machine development, an infrared-imageable presensitized plate composed of a support on which has been provided a water-soluble or water-dispersible photosensitive layer that includes an infrared absorber (A), a radical polymerization initiator (B) and a radical-polymerizable compound (C). This presensitized plate has a high chemical bond density in the image areas, and thus has an excellent press life.

### SUMMARY OF THE INVENTION

However, we have found that the presensitized plates described in JP 2002-287334 A, when used in printing that involves on-machine development, require that a large amount of paper be expended before the image recording layer in non-image areas is completely removed. Hence, there is clearly room for substantial improvement in the on-machine developability of such presensitized plates.

It is therefore one object of the invention to provide a presensitized plate of excellent on-machine developability that has an image-recording layer which includes an infrared absorber, a polymerization initiator and a polymerizable compound, and which can be removed with printing ink and/or dampening water. Another object of the invention is to provide a lithographic printing method which uses such a presensitized plate.

In addition, we have further found that the presensitized plates described in JP 2002-287334 A have a difficulty with removing the image recording layer with printing ink and/or dampening water since the image recording layer has entered into the micropores in the anodized layer. Moreover, we have found that the presensitized plate would exhibit a significantly improved on-machine developability if sealing treatment is performed, following formation of an anodized layer.

Based on these findings, we have completed the present invention.

The present invention provides the following presensitized plate (1) to (18) and a lithographic printing method (19).

(1) A presensitized plate comprising:
a support for a lithographic printing plate obtainable by forming on an aluminum plate at least an anodized layer, then performing sealing treatment; and
an image recording layer which is provided on the support, includes an infrared absorber (A), a polymerization initiator (B), and a polymerizable compound (C), and can be removed with printing ink and/or dampening water.

(2) The presensitized plate according to the above (1), wherein the sealing treatment is carried out with an aqueous solution containing an inorganic fluorine compound.

(3) The presensitized plate according to the above (2), wherein-the inorganic fluorine compound has a concentration in the aqueous solution of 0.01 to 1 wt %.

(4) The presensitized plate according to the above (2) or (3), wherein the aqueous solution contains also a phosphate compound.

(5) The presensitized plate according to the above (4), wherein the aqueous solution contains as the inorganic fluorine compound at least sodium hexafluorozirconate and contains as the phosphate compound at least sodium dihydrogenphosphate.

(6) The presensitized plate according to the above (4) or (5), wherein the phosphate compound has a concentration in the aqueous solution of 0.01 to 20 wt %.

(7) The presensitized plate according to any one of the above (2) to (6), wherein the sealing treatment is carried out at a temperature in the range of 20 to 100° C.

(8) The presensitized plate according to any one of the above (2) to (7), wherein the sealing treatment is carried out for a period of from 1 to 100 seconds.

(9) The presensitized plate according to the above (1), wherein the sealing treatment is carried out with steam.

(10) The presensitized plate according to the above (9), wherein the sealing treatment is carried out at a temperature in the range of 80 to 105° C.

(11) The presensitized plate according to the above (1), wherein the sealing treatment is carried out with hot water.

(12) The presensitized plate according to the above (11), wherein the sealing treatment is carried out at a temperature in the range of 80 to 100° C.

(13) The presensitized plate according to any one of the above (9) to (12), wherein the sealing treatment is carried out for a period of from 1 to 100 seconds.

(14) The presensitized plate according to any one of the above (1) to (13), wherein a fracture plane of the anodized layer after the image recording layer has been provided on the support has the atomic ratio of carbon to aluminum (C/Al) expressed by formula (1) below of at most 1.0;
C/Al=(I_{c}/S_{c})/(Iₐₗ/Sₐₗ) (1),
wherein
I_{c} is the carbon (KLL) Auger electron differential peak-to-peak intensity,
Iₐₗ is the aluminum (KLL) Auger electron differential peak-to-peak intensity,
S_{c} is the carbon (KLL) Auger electron relative sensitivity factor, and
Sₐₗ is the aluminum (KLL) Auger electron relative sensitivity factor.

(15) The presensitized plate according to any one of the above (1) to (14), wherein the support is obtainable by performing hydrophilizing treatment after the sealing treatment.

(16) The presensitized plate according to the above (15), wherein the hydrophilizing treatment is carried out with an aqueous solution containing an alkali metal silicate.

(17) The presensitized plate according to the above (15) or (16), wherein the hydrophilizing treatment is carried out at a temperature in the range of 20 to 100° C.

(18) The presensitized plate according to any one of the above (1) to (17), wherein at least some of the infrared absorber (A), polymerization initiator (B) and polymerizable compound (C) is microencapsulated.

(19) A lithographic printing method which includes the steps of imagewise exposing the presensitized plate according to any one of the above (1) to (18) with an infrared laser, supplying printing ink and dampening water to the exposed plate to print.

The presensitized plates according to the present invention exhibit excellent on-machine developability, sensitivity, scumming resistance, chemical resistance and press life. Accordingly, the lithographic printing method of the present invention using the presensitized plates enables to develop the plate on machine and subsequently perform printing, without passing through processing step.

This application claims priority on Japanese patent application No.2003-329951, the entire contents of which are hereby incorporated by reference. In addition, the entire contents of literatures cited in this specification are incorporated by reference.

### BRIEF DESCRIPTION OF THE DIAGRAMS

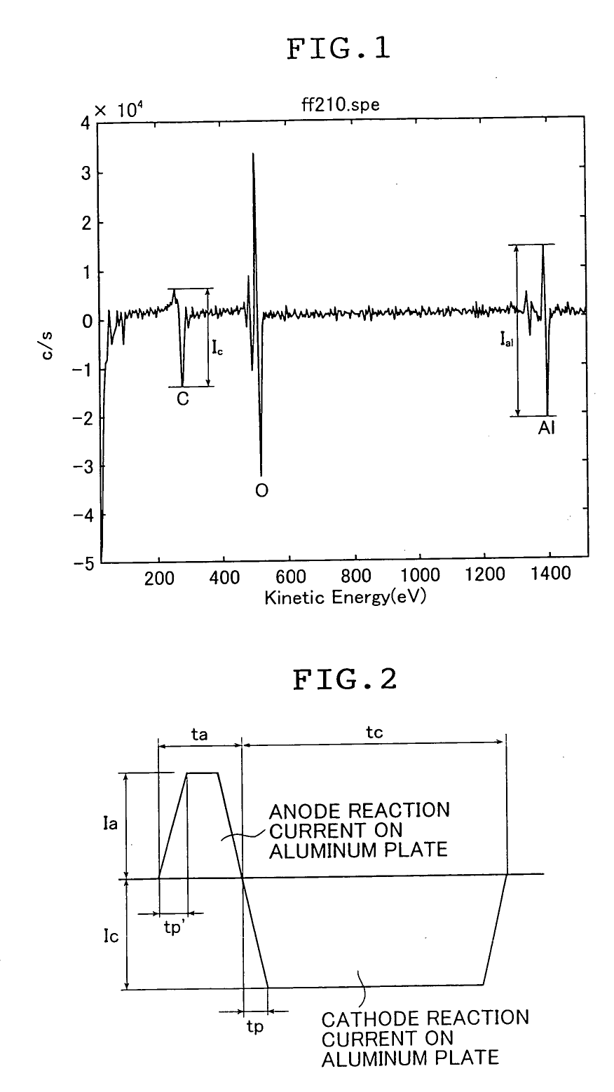

FIG. 1 shows an exemplary chart obtained by carrying out Auger electron spectroscopic analysis of the fracture plane of the anodized layer on a presensitized plate.

FIG. 2 is a waveform diagram showing an example of an alternating current trapezoidal waveform in electrochemical graining treatment such as may be advantageously used in the present invention.

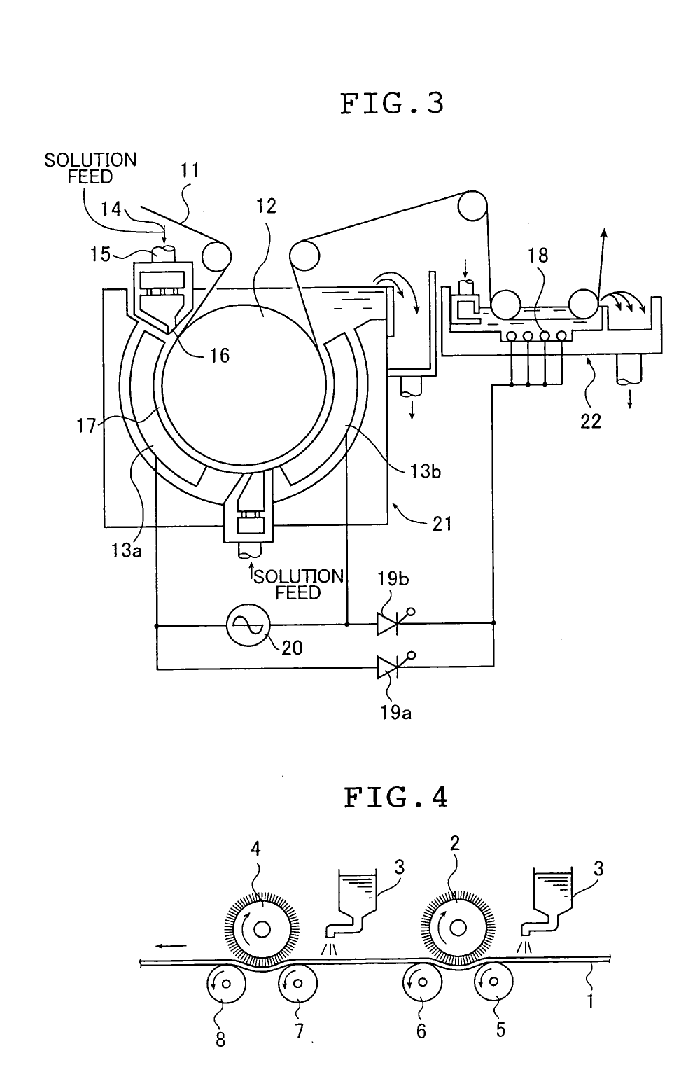

FIG. 3 is a side view showing an example of a radial electrolytic cell apparatus for carrying out electrochemical graining treatment such as may be advantageously used in the invention.

FIG. 4 is a schematic side view of a brush graining step in mechanical graining treatment such as may be advantageously carried out in the present invention.

### DETAILED DESCRIPTION OF THE INVENTION

The invention is described more fully below.

Aluminum Plate (Rolled Aluminum):

Aluminum plate that may be used in the presensitized plate of the invention is made of a dimensionally stable metal composed primarily of aluminum; that is, aluminum or aluminum alloy. Aside from plates of pure aluminum, use can also be made of alloy plates composed primarily of aluminum and small amounts of other elements, or plastic film or paper onto which aluminum or aluminum alloy has been laminated or vapor deposited. Use can also be made of a composite sheet obtained by bonding an aluminum sheet onto a polyethylene terephthalate film as described in JP 48-18327 B (the term “JP XX-XXXXXX B” as used herein means an “examined Japanese patent publication”).

Aluminum plate that may be used in the invention is not subject to any particular limitation, although the use of pure aluminum plate is preferred. However, because completely pure aluminum is difficult to manufacture for reasons having to do with refining technology, the presence of a small amount of other elements is acceptable. Suitable use can be made of known materials that appear in the 4^{th} edition of Aluminum Handbook published in 1990 by the Japan Light Metal Association. Examples of such aluminum materials include those having the designations JIS 1050, JIS 1100, JIS 3003, JIS 3005 and internationally registered alloy designation 3103A. Use can also be made of aluminum plate made from aluminum alloy, scrap aluminum or secondary aluminum ingots having an aluminum content of 95 to 99.4 wt %, and containing five or more metals from among iron, silicon, copper, magnesium, manganese, zinc, chromium and titanium within the ranges indicated below.

The support for a lithographic printing plate used in the invention is preferably made of an aluminum alloy. The aluminum alloy preferably contains aluminum, iron, silicon and copper, and more preferably contains also titanium.

Iron is generally included in the aluminum alloy used as the starting material (aluminum ingot) in an amount of about 0.04 to about 0.2 wt %. The amount of iron that enters into a solid solution within aluminum is small; most remains in the form of intermetallic compounds. Iron increases the mechanical strength of the aluminum alloy, and has a large influence on the strength of the support. If the iron content is too low, the support has a low mechanical strength, which may lead to the formation of breaks in the plate when it is mounted on the plate cylinder of the printing press. Breaks in the plate also tend to arise when a large number of impressions are printed at a high speed. On the other hand, if the iron content is too high, the support will have a higher strength than necessary. As a result, the printing plate, when mounted onto the plate cylinder of the press, may have a poor fit and may thus be subject to the formation of breaks during printing. Also, at an iron content of more than 1.0 wt %, for example, cracks tend to form easily during rolling.

We have found that the iron-containing intermetallic compounds described below account for most of the intermetallic compounds present in the aluminum sheet, and that these compounds are readily shed during graining treatment. Such shedding results in the formation of localized depressions into which the image recording layer enters, causing exposure defects and leading in turn to development defects.

In this invention, based on the above findings, by setting the upper limit in the iron content at preferably 0.29 wt %, an excellent mechanical strength can be obtained. Moreover, the amount of iron-containing intermetallic compounds decreases, and fewer localized depressions form due to shedding of the intermetallic compounds. Consequently, exposure defects, and in turn development defects, are less likely to arise, in addition to which an outstanding sensitivity is achieved.

Taking into account the iron content of the aluminum ingot, the lower limit in the iron content is preferably 0.05 wt %, although an iron content of at least 0.20 wt % is more preferable for sustaining the mechanical strength of the aluminum sheet.

Illustrative examples of iron-containing intermetallic compounds include Al₃Fe, Al₆Fe, Al—Fe—Si compounds and Al—Fe—Si—Mn compounds.

Silicon is an element which is present in an amount of about 0.03 to 0.1 wt % as an inadvertent impurity in the aluminum ingot serving as the starting material. A very small amount is often intentionally added to prevent variation due to starting material differences. Silicon is also abundant in scrap aluminum. Silicon exists within aluminum as a solid solution, or is present in the form of intermetallic compounds or as an uncombined precipitate. When the aluminum plate is heated during the support for a lithographic printing plate manufacturing process, silicon that was present in the aluminum as a solid solution sometimes precipitates out as uncombined silicon. According to our findings, too much uncombined silicon can lower the resistance to severe ink scumming. Here, “severe ink scumming” refers to contamination in the form of spots and rings that appear on the printed medium such as paper as a result of the tendency for ink to adhere to non-image areas of the printing plate surface when printing is carried out with repeated interruptions. Silicon also has an effect on electrolytic graining treatment.

If the silicon content is too high, when anodizing treatment is performed after graining treatment, defects arise in the anodized layer. These defective areas have a poor water retention and tend to result in scumming of the paper during printing.

In the practice of the invention, the silicon content is preferably at least 0.03 wt % but not more than 0.15 wt %. For excellent stability in electrolytic graining treatment, a silicon content of at least 0.04 wt % but not more than 0.1 wt % is especially preferred.

Copper is an element which controls electrolytic graining treatment and is very significant. By having the copper content be preferably at least 0.020 wt %, the diameter of the pits formed by electrolytic graining treatment in a nitric acid solution can be increased. As a result, when printing is carried out following exposure and development of the presensitized plate, dampening water retention in the non-image areas can be greatly increased, thereby enhancing scumming resistance. On the other hand, at a copper content of more than 0.050 wt %, the pits formed by electrolytic graining treatment in a nitric acid solution have diameters which are too large and of decreased uniformity, which may lower the scumming resistance of the plate.

We have found that by setting the copper content within this range, the pits having a diameter of up to 0.5 μm which form as a result of electrolyte graining treatment in a hydrochloric acid solution can be made uniform, and the percent increase in the surface area of the support can be maximized. A greater percent increase in the surface area of the support enables the surface area of contact with the image recording layer to be increased, improving the bond strength therebetween. The result is an excellent press life in general and an excellent press life on exposure to cleaners in particular. Moreover, the lithographic printing plate obtained from the presensitized plate has an excellent scumming resistance.

Based on these considerations, the copper content in the practice of the invention is preferably from 0.020 to 0.050 wt %, and more preferably from 0.020 to 0.030 wt %.

Titanium has hitherto been included in a content of generally up to 0.05 wt % as a crystal grain refining agent to achieve a finer crystal structure during casting. Too high a titanium content will make the resistance of the surface oxide film to electrolytic graining treatment too small, particularly during electrolytic graining treatment with an aqueous solution of nitric acid, as a result of which uniform pits may not form. In the practice of the invention, the titanium content is preferably not more than 0.05 wt %, and more preferably not more than 0.03 wt %.

Titanium may or may not be present in the aluminum sheet, or may be present in a low content. However, to increase the crystal grain refining effects, the titanium content is preferably at least 0.005 wt %, and more preferably at least 0.01 wt %.

Titanium is added primarily as intermetallic compounds with aluminum or as TiB₂. However, to increase its crystal grain refining effects, addition as an aluminum-titanium alloy or an aluminum-boron-titanium alloy is preferred. When it is added as an aluminum-boron-titanium alloy, a trace amount of boron is present in the aluminum alloy, but this does not compromise the objects and desired effects of the invention.

By using an aluminum plate containing the other above elements within the indicated ranges, large, uniform pits are formed in the subsequently described electrolytic graining treatment. Accordingly, such a plate, when rendered into a lithographic printing plate, has an excellent sensitivity, excellent press life after cleaner application (chemical resistance), excellent press life and excellent scumming resistance.

The balance of the aluminum plate is preferably made up of aluminum and inadvertent impurities. Most of the inadvertent impurities are present in the aluminum ingot. If the inadvertent impurities are present in an ingot having an aluminum purity of 99.7%, they will not compromise the desired effects of the invention. The inadvertent impurities may be, for example, impurities included in the amounts mentioned in Aluminum Alloys: Structure and Properties, by L. F. Mondolfo (1976).

Examples of inadvertent impurities present in aluminum alloys include magnesium, manganese, zinc and chromium. These are present in respective amounts of preferably not more than 0.05 wt %. Elements other than these may also be present in amounts known to the art.

The aluminum plate used in the invention is manufactured by using a conventional process to cast the above-described starting material, performing suitable rolling treatment and heat treatment to set the thickness to typically 0.1 to 0.7 mm, and applying flatness correcting treatment as required. This thickness can be suitably varied according to the size of the printing press, the size of the printing plate, and the desires of the user.

Processes that may be used to manufacture the above aluminum plate include direct-chill casting, a process like direct-chill casting but from which soaking treatment and/or annealing treatment have been omitted, and continuous casting.

The support for a lithographic printing plate used in the presensitized plate of the invention is obtainable by forming on the above-described aluminum plate at least an anodized layer then performing sealing treatment, although the production process may include various other steps as well.

The aluminum plate preferably passes through a degreasing step to remove rolling oils adhering to the surface of the sheet, a desmutting step to dissolve smut on the surface of the plate, a graining treatment step to roughen the surface of the plate, an anodizing treatment step to form an anodized layer on the surface of the aluminum plate, and sealing treatment to seal micropores in the anodized layer, thereby giving a support for a lithographic printing plate.

Production of the support for a lithographic printing plate used in the invention preferably includes electrochemical graining treatment in which an alternating current is used to electrochemically grain the aluminum plate in an acidic aqueous solution.

Production of the support for a lithographic printing plate used in the invention may include an aluminum plate surface treatment step which combines the above-described electrochemical graining treatment with an operation such as mechanical graining treatment or chemical etching treatment in an acid or alkaline aqueous solution. The graining treatment and other steps employed to produce the support for a lithographic printing plate used in the invention may be carried out as either a continuous or an intermittent process, although the use of a continuous process is industrially advantageous.

In the practice of the invention, hydrophilizing treatment may also be carried out if necessary.

More specifically, a process which carries out the following steps in the indicated order is preferred: (a) mechanical graining treatment, (b) alkali etching treatment, (c) desmutting treatment, (d) electrolytic graining treatment using an electrolytic solution composed primarily of nitric acid (nitric acid electrolysis), (e) alkali etching treatment, (f) desmutting treatment, (g) electrolytic graining treatment using an electrolytic solution composed primarily of hydrochloric acid (hydrochloric acid electrolysis), (h) alkali etching treatment, (i) desmutting treatment, (j) anodizing treatment, (k) sealing treatment, and (1) hydrophilizing treatment.

Preferred use can also be made of a process which omits steps (g) to (i) from the above process, a process which omits step (a) from the above process, a process which omits step (a) and steps (g) to (i) from the above process, and a process which omits steps (a) to (d) from the above process.

Graining Treatment:

First, graining treatment is described.

The above-described aluminum plate is performed graining treatment to impart a more desirable surface shape. Illustrative examples of suitable graining methods include mechanical graining, chemical etching and electrolytic graining techniques like those described in JP 56-28893 A. Use can also be made of electrochemical graining and electrolytic graining processes in which the surface is electrochemically grained in an electrolytic solution containing hydrochloric acid or nitric acid; and mechanical graining such as wire brushing in which the aluminum surface is scratched with metal wires, ball graining in which the aluminum surface is grained with abrasive balls and an abrasive compound, and brush graining in which the surface is grained with a nylon brush and an abrasive compound. Any one or combination of these graining methods may be used. For example, mechanical graining with a nylon brush and an abrasive compound may be combined with electrolytic graining using an electrolytic solution of hydrochloric acid or nitric acid, or a plurality of electrolytic graining treatments may be combined. Of the above, electrochemical graining is preferred, although it is also advantageous to carry out a combination of mechanical graining and electrochemical graining. Mechanical graining followed by electrochemical graining is especially preferred.

Mechanical graining refers to treatment in which the surface of the aluminum plate is mechanically grained such as with a brush. It is preferably carried out before the above electrochemical graining treatment.

Suitable mechanical graining treatment involves carrying out treatment with a rotating nylon brush roll having a bristle diameter of 0.07 to 0.57 mm and an abrasive compound that is supplied as a slurry to the surface of the aluminum plate.

The nylon brush is preferably made of bristles having a low water absorption. A preferred example is Nylon Bristle 200T (available from Toray Industries, Inc.), which is made of nylon 6/10, has a softening point of 180° C., a melting point of 212 to 214° C., a specific gravity of 1.08 to 1.09, a water content at 20° C. and 65.% relative humidity of 1.4 to 1.8 and at 20° C. and 100% relative humidity of 2.2 to 2.8, a dry tensile strength of 4.5 to 6 g/d, a dry tensile elongation of 20 to 35%, a boiling water shrinkage of 1 to 4%, a dry resistance to stretching of 39 to 45 g/d, and a Young's modulus when dry of 380 to 440 kg/mm².

Any known abrasive compound may be used, although the use of silica sand, quartz, aluminum hydroxide, or a mixture thereof, mentioned in JP 6-135175 A and JP 50-40047 B is preferred.

The slurry is preferably one having a specific gravity in a range of 1.05 to 1.3. Illustrative examples of methods for supplying the slurry to the surface of the aluminum plate include blowing the slurry onto the surface, a method involving the use of a wire brush, and a method in which the pattern-indented surface shape of a reduction roll is transferred to the aluminum plate. The methods described in JP 55-74898 A, JP 61-162351 A and JP 63-104889 A may also be used. Moreover, use can also be made of a method like that described in JP 9-509108 A, wherein the surface of the aluminum plate is brush grained in an aqueous slurry containing a mixture of particles composed of alumina and quartz in a weight ratio of 95:5 to 5:95. The mixture used for this purpose has an average particle size of preferably 1 to 40 μm, and more preferably 1 to 20 μm.

Electrochemical graining differs from the subsequently described mechanical graining in that it involves graining the surface of the aluminum plate electrochemically by placing the plate in an acidic aqueous solution and passing through an alternating current with the plate serving as an electrode.

In the practice of the invention, when the ratio Q_{C}/Q_{A} between the amount of electricity. Q_{C} when the aluminum plate serves as the cathode in the above electrochemical graining treatment and the amount of electricity Q_{A} when the plate serves as the anode is within a range of 0.5 to 2.0, for example, uniform honeycomb pits can be formed on the surface of the aluminum plate. Non-uniform honeycomb pits tend to form at a Q_{C}/Q_{A} ratio of less than 0.50 or more than 2.0. A Q_{C}/Q_{A} ratio within a range of 0.8 to 1.5 is preferred.

The alternating current used in electrochemical graining may have a waveform that is, for example, sinusoidal, square, triangular or trapezoidal. Of these, a square or trapezoidal waveform is preferred. The alternating current has a frequency which, from the standpoint of the cost of manufacturing the power supply, is preferably 30 to 200 Hz, more preferably 40 to 120 Hz, and even more preferably 50 to 60 Hz.

FIG. 2 shows an example of a trapezoidal wave that can be suitably used in the invention. In FIG. 2, the ordinate represents the current value and the abscissa represents time. In addition, ta is the anode reaction time, tc is the cathode reaction time, tp is the time until the current value reaches a peak on the cathode cycle side from zero, tp′ is the time until the current value reaches a peak on the anode cycle side from zero, Ia is the peak current on the anode cycle side, and Ic is the peak current on the cathode cycle side. When trapezoidal waves are used as the alternating current waveform, the respective times tp and tp′ until the current reaches a peak from zero are preferably each from 0.1 to 2 msec, and more preferably from 0.3 to 1.5 msec. When tp and tp′ are less than 0.1 msec, the power circuit impedance exerts an influence, requiring a large power supply voltage during rise in the current waveform, which may increase the cost of the power supply equipment. On the other hand, when tp and tp′ are more than 2 msec, the influence by trace components within the acidic aqueous solution becomes large, which may make it more difficult to carry out uniform graining treatment.

To uniformly grain the surface of the aluminum plate, it is preferable for the alternating current used in electrochemical graining to have a duty ratio within a range of 0.25 to 0.75, and especially 0.4 to 0.6. As used herein, “duty ratio” refers to the ratio ta/T, where T is the period of the alternating current and ta is the duration of the anode reaction at the aluminum plate (anode reaction time). In particular, smut components composed largely of aluminum hydroxide form on the surface of the aluminum plate during the cathode reaction, in addition to which oxide film dissolution and breakdown occur, becoming the starting points of pitting reactions during the subsequent anode reaction at the aluminum plate. Hence, selection of the alternating current duty ratio has a large effect on providing uniform graining treatment.

The alternating current has a current density, in the case of a trapezoidal or square waveform, which is preferably such that the current density Iap at the peak on the anode cycle side and the current density Icp at the peak on the cathode cycle side are each from 10 to 200 A/dm². Moreover, the ratio Icp/Iap is preferably within a range of 0.9 to 1.5.

The total amount of electricity used in the anode reaction on the aluminum plate when electrochemical graining treatment has been completed is preferably from 50 to 1,000 C/dm². The electrochemical graining time is preferably from 1 second to 30 minutes.

Any acidic aqueous solution used in conventional electrochemical graining treatment involving the use of direct current or alternating current may be employed here in electrochemical graining treatment, although the use of an acidic aqueous solution composed mainly of nitric acid or an acidic aqueous solution composed mainly of hydrochloric acid is preferred. “Composed mainly of,” as used here and below, signifies that the main component in an aqueous solution is included in an amount of at least 30 wt %, and preferably at least 50 wt %, based on all the components within the solution.

As noted above, the acidic aqueous solution composed mainly of nitric acid can be one which is employed in conventional electrochemical graining treatment involving the use of direct current or alternating current. For example, use can be made of a nitric acid solution with a nitric acid concentration of 5 to 15 g/L in which one or more nitric acid compound such as aluminum nitrate, sodium nitrate or ammonium nitrate has been added to a concentration of from 0.01 g/L to saturation. The acidic aqueous solution composed mainly of nitric acid may contain, dissolved therein, metals which are present in aluminum alloy, such as iron, copper, manganese, nickel, titanium, magnesium and silicon.

It is advantageous for the acidic solution composed mainly of nitric acid used in the invention to be one which contains nitric acid, an aluminum salt and a nitrate, and which has been obtained by adding aluminum nitrate and ammonium nitrate to a nitric acid solution having a nitric acid concentration of 5 to 15 g/L so as to set the aluminum ion concentration to 1 to 15 g/L, and preferably 1 to 10 g/L, and the ammonium ion concentration to 10 to 300 ppm. The aluminum ions and ammonium ions form spontaneously and thus increase while electrochemical graining is being carried out. The liquid temperature at this time is preferably 10 to 95° C., more preferably 20 to 90° C., and most preferably 30 to 70° C.

In electrochemical graining treatment, use can be made of a known electrolytic cell apparatus, such as one having a vertical, flat or radial construction. A radial electrolytic cell apparatus like that described in JP 5-195300 A is especially preferred.

FIG. 3 is a schematic view of a radial electrolytic cell apparatus of a type suitable for use in the practice of the invention. In FIG. 3, an aluminum plate 11 wraps around a radial drum roller 12 situated within a main electrolytic cell 21 and passes through the apparatus while being subjected to electrolytic treatment by means of main electrodes 13a and 13b connected to an AC power supply 20. The acidic aqueous solution 14 is supplied from a solution feed inlet 15 through a slit 16, and to a solution channel 17 located between the radial drum roller 12 and the main electrodes 13a and 13b.

Next, the aluminum plate 11 treated in the main electrolytic cell 21 is electrolytically treated in an auxiliary anode cell 22. In this auxiliary anode cell 22, an auxiliary anode 18 is situated opposite the aluminum plate 11 and the acidic aqueous solution 14 is supplied such as to flow between the auxiliary anode 18 and the aluminum plate 11. The current supplied to the auxiliary anode 18 is controlled by thyristors 19a and 19b.

Main electrodes 13a and 13b may be selected from among carbon, platinum, titanium, niobium, zirconium, stainless steel and electrodes used in fuel cell cathodes, although carbon is especially preferred. Examples of carbon that may be used for this purpose include ordinary commercially available impervious graphite for chemical equipment, and resin-impregnated graphite.

The auxiliary anode 18 may be selected from among known oxygen generating electrodes made of ferrite, iridium oxide, platinum, or platinum that has been clad or plated with a valve metal such as titanium, niobium or zirconium.

The acidic aqueous solution which passes through the main electrolytic cell 21 and the auxiliary anode cell 22 may be fed in a direction that is either parallel or counter to the direction of advance by the aluminum plate 11. The acidic aqueous solution has a flow rate with respect to the aluminum plate of preferably 10 to 1,000 cm/s.

One or more AC power supply may be connected to a single electrolytic cell apparatus. It is also possible to use two or more electrolytic cell apparatuses, in which case the electrolysis conditions in each apparatus may be the same or different.

Following the completion of electrolytic treatment, it is desirable to drain the solution from the treated aluminum plate with a nip roller and rinse the plate by spraying it with water to prevent the treatment solution from being carried on to the next step.

In cases where the above-described electrolytic cell apparatus is used, it is desirable to add nitric acid and water while adjusting the amounts of addition in proportion to the amount of electricity passed through the acidic aqueous solution in which the aluminum plate within the electrolytic cell apparatus undergoes anodic reaction, and based on the nitric acid and aluminum ion concentrations determined from, for example, (i) the electrical conductivity of the acidic aqueous solution, (ii) the ultrasonic wave propagation velocity of the solution and (iii) the solution temperature. It is also desirable to keep the concentration of the acidic aqueous solution constant by successively allowing to overflow and thus discharging from the electrolytic cell apparatus an amount of the acidic aqueous solution equivalent to the volume of nitric acid and water added.

Next, surface treatment, including chemical etching treatment in an acidic aqueous solution or an alkaline aqueous solution and desmutting treatment, are described in this order. These surface treatments are each carried out either before the above-described electrochemical graining treatment, or after electrochemical graining treatment but before the anodizing treatment described later in the specification. Descriptions of each of the surface treatments are given below, although the invention is not limited to the particular surface treatments as they are described below. These surface treatments and the other treatments mentioned below are optionally performed.

Alkali Etching Treatment:

Alkali etching treatment is a treatment in which the surface of the aluminum plate is chemically etched in an alkaline aqueous solution, and is preferably carried out before and after the above-described electrochemical graining treatment. In cases where mechanical graining treatment is carried out before electrochemical graining treatment, it is preferable to carry out alkali etching treatment after mechanical graining treatment. Alkali etching treatment can break down the microstructure in a short time, and is thus more advantageous than the subsequently described acidic etching treatment.

Illustrative examples of alkaline aqueous solutions that may be used in alkali etching treatment include aqueous solutions containing one or more of the following: sodium hydroxide, sodium carbonate, sodium aluminate, sodium metasilicate, sodium phosphate, potassium hydroxide, lithium hydroxide and the like. An aqueous solution composed mainly of sodium hydroxide is especially preferred. The alkaline aqueous solution may contain 0.5 to 10 wt % of aluminum and/or alloying ingredients present in the aluminum plate.

The alkaline aqueous solution has a concentration of preferably 1 to 50 wt %, and more preferably 1 to 30 wt %.

It is advantageous to carry out alkali etching treatment for 1 to 120 seconds, and preferably 2 to 60 seconds, at an alkaline aqueous solution temperature in a range of 20 to 100° C., and preferably 40 to 80° C. The amount of dissolved aluminum is preferably 5 to 20 g/m² when alkali etching treatment is carried out after mechanical graining, and preferably 0.01 to 10 g/m² when alkali etching treatment is carried out after electrochemical graining. When a chemical etching solution is initially mixed into the alkaline aqueous solution, it is preferable to prepare the treatment solution using liquid sodium hydroxide and sodium aluminate.

Following the completion of alkali etching treatment, it is desirable to drain the solution from the treated aluminum plate with a nip roller and rinse the plate by spraying it with water to prevent the treatment solution from being carried on to the next step.

When alkali etching treatment is carried out after electrochemical graining, the smut that forms from electrochemical graining can be removed. Preferred examples of such alkali etching treatments include a method in which the aluminum plate is brought into contact with 15 to 65 wt % sulfuric acid at a temperature of 50 to 90° C., as described in JP 53-12739 A, and the alkali etching method described in JP 48-28123 B.

Acidic Etching Treatment:

Acidic etching treatment is a treatment in which the aluminum plate is chemically etched in an acidic aqueous solution. It is preferably carried out after the electrochemical graining treatment described above. In cases where the above-described alkali etching treatment is carried out before and/or after electrochemical graining, it is preferable for acidic etching treatment to be carried out after alkali etching treatment.

When acidic etching treatment is performed following alkali etching treatment of the aluminum plate, silica-containing intermetallic compounds and uncombined silicon can be removed from the surface of the aluminum plate, thus making it possible to eliminate defects in the anodized layer that forms in the subsequent anodizing treatment. As a result, the adherence of ink spots in non-image areas during printing can be prevented.

Examples of acidic aqueous solutions that may be used in acidic etching treatment include aqueous solutions containing phosphoric acid, nitric acid, sulfuric acid, chromic acid, hydrochloric acid, or a mixture of two or more thereof. Of these, an aqueous solution of sulfuric acid is preferred. The acidic aqueous solution has a concentration of preferably 50 to 500 g/L. The acidic aqueous solution may contain aluminum and/or the alloying ingredients present in the aluminum plate.

It is advantageous to carry out acidic etching treatment at a liquid temperature of 60 to 90° C., and preferably 70 to 80° C., for a period of 1 to 10 seconds. The amount of aluminum plate dissolution at this time is preferably from 0.001 to 0.2 g/m². The acid concentration, such as the sulfuric acid concentration and aluminum ion concentration, is preferably selected from a range at which crystallization does not occur at room temperature. The aluminum ion concentration is preferably 0.1 to 50 g/L, and more preferably 5 to 15 g/L.

Following the completion of acidic etching treatment, it is desirable to drain the solution from the treated aluminum plate with a nip roller and rinse the sheet by spraying it with water to prevent the treatment solution from being carried on to the next step.

Desmutting:

When the above alkali etching treatment is carried out before and/or after electrochemical graining, smut generally forms on the surface of the aluminum plate as a result of alkali etching treatment. Therefore, following alkali etching treatment, it is desirable to carry out a so-called desmutting treatment in which such smut is dissolved in an acidic solution containing phosphoric acid, nitric acid, sulfuric acid, chromic acid, hydrochloric acid, hydrofluoric acid, fluoroboric acid or a mixture of two or more of these acids. Following alkali etching treatment, if is sufficient to carry out either acidic etching treatment or desmutting.

The concentration of the acidic solution is preferably 1 to 500 g/L. The acidic solution may have dissolved therein 0.001 to 50 g/L of aluminum and/or the alloying ingredients present in the aluminum plate.

The acidic solution has a liquid temperature of preferably 20 to 95° C., and more preferably 30 to 70° C. The treatment time is preferably 1 to 120 seconds, and more preferably 2 to 60 seconds.

To reduce the amount of wastewater generated, it is preferable to use wastewater from the acidic aqueous solution employed in electrochemical graining as the desmutting solution (acidic solution).

Following the completion of desmutting, it is desirable to drain the solution from the treated aluminum plate with a nip roller and rinse the plate by spraying it with water to prevent the treatment solution from being carried on to the next step.

Anodizing Treatment:

After being subjected to the various above-described treatments as needed, the aluminum plate is subjected to anodizing treatment to form thereon an anodized layer.

Anodizing treatment can be carried out by any suitable method used in the art to which the invention relates. More specifically, an anodizing layer can be formed on the surface of the aluminum plate by passing a direct current or alternating current through the aluminum plate in an aqueous or non-aqueous solution of any one or combination of, for example, sulfuric acid, phosphoric acid, chromic acid, oxalic acid, sulfamic acid, benzenesulfonic acid and the like.

The anodizing treatment conditions vary empirically according to the electrolytic solution used, although it is generally suitable for the solution to have a concentration of 1 to 80 wt % and a temperature of 5 to 70° C., and for the current density to be 0.5 to 60 A/dm², the voltage to be 1 to 200 V, and the electrolysis time to be 1 to 1,000 seconds.

Of such anodizing treatments, the anodizing process carried out in a sulfuric acid electrolytic solution at a high current density described in GB 1,412,768 B and the anodizing process carried out using phosphoric acid as the electrolytic bath described in U.S. Pat. No. 3,511,661 are preferred. It is also possible to carry out a multi-step anodizing treatment involving, for example, anodizing treatment in sulfuric acid and also anodizing treatment in phosphoric acid.

In the practice of the invention, to minimize scuffing and improve the press life of the plate, the anodized layer has a weight of preferably at least 0.5 g/m², more preferably at least 1.0 g/m², and even more preferably 2.0 g/m². Given that a large amount of energy is required to provide a thick layer, the anodized layer has a weight of preferably not more than 100 g/m², more preferably not more than 10 g/m², and even more preferably not more than 6 g/m².

Minute depressions called micropores are formed so as to be uniformly distributed over the surface of the anodized layer. The density of the micropores present on the anodized layer can be adjusted by suitable selection of the treatment conditions.

Sealing Treatment:

In the practice of the invention, sealing treatment is carried out following formation of an anodized layer on the aluminum plate as described above. Sealing treatment reduces the diameter of the micropores in the anodized layer, thus making it possible to prevent the image recording layer from entering the micropores during manufacture of the presensitized plate. As a result, the on-machine developability of the resulting presensitized plate is greatly enhanced.

Such sealing treatment can also reduce the amount of residual image recording film following on-machine development, making it possible to render the surface of the lithographic printing plate hydrophilic in non-image areas, and thus giving the plate an excellent scumming resistance. Moreover, because sealing treatment reduces the diameter of micropores in the anodized layer, it can inhibit the entry of ink therein during printing, which also helps to provide the plate with excellent scumming resistance.

Furthermore, because such sealing treatment can form micro-asperities of 10 to 100 nm on the surface of the lithographic printing plate support, the surface area of the support increases and bond strength with the image recording layer is thereby enhanced, resulting in excellent sensitivity and chemical resistance.

Any suitable known sealing method may be used without particular limitation to carry out sealing treatment in the invention. However, the use of sealing treatment with an aqueous solution containing an inorganic fluorine compound, sealing treatment with steam or sealing treatment with hot water is preferred. Each of these is described below. Sealing Treatment with an Aqueous Solution Containing an

Inorganic Fluorine Compound:

Preferred inorganic fluorine compounds that may be used in sealing treatment with an inorganic fluorine compound-containing aqueous solution include metal fluorides such as sodium fluoride, potassium fluoride, calcium fluoride, magnesium fluoride, sodium fluorozirconate, potassium fluorozirconate, sodium fluorotitanate, potassium fluorotitanate, ammonium fluorozirconate, ammonium fluorotitanate, fluorozirconic acid, fluorotitanic acid, fluorosilicic acid, nickel fluoride, iron fluoride, fluorophosphoric acid and ammonium fluorophosphate. Of these, sodium fluorozirconate, sodium fluorotitanate, fluorozirconic acid and fluorotitanic acid are preferred.

To carry out sealing of the micropores in the anodized layer to a sufficient degree, the concentration of the inorganic fluorine compound in the aqueous solution is preferably at least 0.01 wt %, and more preferably at least 0.05 wt %. To ensure scumming resistance, the concentration is preferably not more than 1 wt %, and more preferably not more than 0.5 wt %.

It is desirable for the inorganic fluorine compound-containing aqueous solution to include also a phosphate compound. By including a phosphate compound, the hydrophilic properties of the surface of the anodized layer can be improved, thereby making it possible to enhance the on-machine developability and scumming resistance.

Preferred phosphates include the phosphoric acid salts of metals such as alkali metals and alkaline earth metals.

Specific examples include zinc phosphate, aluminum phosphate, ammonium phosphate, diammonium hydrogenphosphate, ammonium dihydrogenphosphate, potassium dihydrogenphosphate, dipotassium hydrogenphosphate, calcium phosphate, ammonium sodium hydrogenphosphate, magnesium hydrogenphosphate, magnesium phosphate, iron (II) phosphate, iron (III) phosphate, sodium dihydrogenphosphate, sodium phosphate, disodium hydrogenphosphate, lead phosphate, calcium dihydrogenphosphate, lithium phosphate, phosphotungstic acid, ammonium phosphotungstate, sodium phosphotungstate, ammonium phosphomolybdate, sodium phosphomolybdate, sodium phosphite, sodium tripolyphosphate and sodium pyrophosphate. Of these, sodium diydrogenphosphate, sodium hydrogenphosphate, potassium dihydrogenphosphate and potassium hydrogenphosphate are preferred.

No particular limitation is imposed on combinations of the inorganic fluorine compound and the phosphate compound, although it is preferable for the aqueous solution to include at least sodium hexafluorozirconate as the inorganic fluorine compound and at least sodium dihydrogenphosphate as the phosphate compound.

To enhance on-machine developability and scumming resistance, the concentration of phosphate compound within the aqueous solution is preferably at least 0.01 wt %, and more preferably at least 0.1 wt %. For good solubility, the concentration is preferably not more than 20 wt %, and more preferably not more than 5 wt %.

The proportions of the respective compounds in the aqueous solution are not subject to any particular limitation, although the weight ratio of the inorganic fluorine compound to the phosphate compound is preferably from 1/200 to 10/1, and more preferably from 1/30 to 2/1.

The aqueous solution has a temperature of preferably at least 20° C., and more preferably at least 40° C., but preferably not more than 100° C., and more preferably not more than 80° C.

The aqueous solution has a pH of preferably at least 1, and more preferably at least 2, but preferably not more than 11, and more preferably not more than 5.

The method for carrying out sealing treatment using an aqueous solution containing an inorganic fluorine compound is not subject to any particular limitation, and includes for example dipping and spraying. Any one or plurality of these techniques may be used for once or more.

Dipping is especially preferred. When such treatment is carried out by dipping, the treatment time is preferably at least 1 second, and more preferably at least 3 seconds, but preferably not more than 100 seconds, and more preferably not more than 20 seconds.

Sealing Treatment with Steam:

Sealing treatment with steam is exemplified by methods in which pressurized or normal-pressure steam is continuously or discontinuously contacted with the anodized layer.

The steam has a temperature of preferably at least 80° C., more preferably at least 95° C., and even more preferably at least 105° C.

It is preferable for the steam to have a pressure in a range of from (atmospheric pressure−50 mmAq) to (atmospheric pressure+300 mmAq); that is, in a range of from 1.008×10⁵ to 1.043×10⁵ Pa.

The steam contacting period is preferably at least 1 second, and more preferably at least 3 seconds, but preferably not more than 100 seconds, and more preferably not more than 20 seconds.

Sealing Treatment with Hot Water:

Sealing treatment with hot water is exemplified by a method in which the aluminum plate on which an anodized layer has been formed is dipped in hot water.

The hot water may contain an inorganic salt (e.g., a phosphate) or an organic salt.

The hot water has a temperature of preferably at least 80° C., and more preferably at least 95° C., but preferably not more than 100° C.

The hot water dipping period is preferably at least 1 second, and more preferably at least 3 seconds, but preferably not more than 100 seconds, and more preferably not more than 20 seconds.

Hydrophilizing Treatment:

In the practice of the invention, following sealing treatment, it is desirable to perform hydrophilizing treatment. Illustrative examples of hydrophilizing treatment include the phosphomolybdate treatment described in U.S. Pat. No. 3,201,247, the alkyl titanate treatment described in GB 1,108,559 B, the polyacrylic acid treatment described in DE 1,091,433 B, the polyvinylphosphonic acid treatment described in DE 1,134,093 B and GB 1,230,447 B, the phosphonic acid treatment described in JP 44-6409 B, the phytic acid treatment described in U.S. Pat. No. 3,307,951, the treatment with the divalent metal salts of oleophilic organic polymer compounds described in JP 58-16893 A and JP 58-18291 A, the treatment described in U.S. Pat. No. 3,860,426 which provides an undercoat of hydrophilic cellulose (e.g., carboxymethyl cellulose) containing a water-soluble metal salt (e.g., zinc acetate), and the treatment described in JP 59-101651 A which carries out undercoating with a sulfo group-bearing water-soluble polymer.

Additional examples include undercoating treatment with, for example, the phosphates described in JP 62-19494 A, the water-soluble epoxy compounds described in JP 62-33692 A, the phosphoric acid-modified starches described in JP 62-97892 A, the diamine compounds described in JP 63-56498 A, the inorganic or organic acid salts of amino group-bearing compounds described in JP 63-130391 A, the carboxyl or hydroxyl group-bearing organic phosphonic acids described in JP 63-145092 A, the amino group and phosphonic acid group-bearing compounds described in JP 63-165183 A, the specific carboxylic acid derivatives described in JP 2-316290 A, the phosphoric acid esters described in JP 3-215095 A, the compounds having a single amino group and a single phosphorus oxo acid group described in JP 3-261592 A, the aliphatic or aromatic phosphonic acids such as phenylphosphonic acid described in JP 5-246171 A, the sulfur atom-containing compounds such as thiosalicylic acid described in JP 1-307745 A, and the phosphorus oxo acid group-bearing compounds described in JP 4-282637 A.

Coloration with an acid dye as described in JP 60-64352 A can also be carried out.

It is also desirable to carry out hydrophilizing treatment by a method that involves dipping in an aqueous solution of an alkali metal silicate such as sodium silicate or potassium silicate, or a method that involves coating a hydrophilic vinyl polymer or hydrophilic compound to form a hydrophilic undercoat.

Hydrophilizing treatment with an aqueous solution of an alkali metal silicate such as sodium silicate or potassium silicate can be carried out according to the methods and procedures described in U.S. Pat. No. 2,714,066 and U.S. Pat. No. 3,181,461.

Examples of alkali metal silicates include sodium silicate, potassium silicate and lithium silicate. The aqueous solutions of an alkali metal silicate may include a suitable amount of, for example, sodium hydroxide, potassium hydroxide and lithium hydroxide.

The aqueous solution of an alkali metal silicate may include an alkaline-earth metal salt or a group 4 (group IVA) metal salt. Exemplary alkaline-earth metal salts include nitrates such as calcium nitrate, strontium nitrate, magnesium nitrate and barium nitrate; and also sulfates, hydrochlorides, phosphates, acetates, oxalates, and borates. Exemplary group 4 (group IVA) metal salts include titanium tetrachloride, titanium trichloride, titanium potassium fluoride, titanium potassium oxalate, titanium sulfate, titanium tetraiodide, zirconium oxychloride, zirconium dioxide and zirconium tetrachloride. These alkaline-earth metal salts and group 4 (group IVA) metal salts may be used singly or in combinations of two or more thereof.

Hydrophilizing treatment by forming a hydrophilic undercoat can also be carried out in accordance with the conditions and procedures described in JP 59-101651 A and JP 60-149491 A.

Illustrative examples of the hydrophilic vinyl polymer used in this method include copolymers of a sulfo group-bearing vinyl polymerizable compound such as polyvinylsulfonic acid or a sulfo group-bearing p-styrenesulfonic acid with an ordinary vinyl polymerizable compound such as an alkyl (metha)acrylate. Illustrative examples of the hydrophilic compound used in this method include compounds bearing at least one group selected from among —NH₂, —COOH and the sulfo group.

Hydrophilizing treatment is carried out at a temperature in a range of preferably 20 to 100° C., and more preferably 20 to 60° C.

If the method is one involving dipping in an aqueous solution, the dipping time is preferably at least 1 second, and more preferably at least 3 seconds, but not more than preferably 100 seconds, and more preferably not more than 20 seconds.

Back Coat:

If necessary, the support for a lithographic printing plate obtained as described above may be provided on the back side (the side not provided with an image recording layer) with a coat (referred to hereinafter as the “back coat”) composed of an organic polymeric compound so that scuffing of the image recording layer does not occur even when the resulting presensitized plates are stacked on top of one other.

The back coat preferably contains, as the main component, at least one resin which has a glass transition point of at least 20° C. and is selected from the group consisting of saturated copolyester resins, phenoxy resins, polyvinyl acetal resins and vinylidene chloride copolymer resins.

The saturated copolyester resin is composed of dicarboxylic acid units and diol units. Examples of the dicarboxylic acid units include aromatic dicarboxylic acids such as phthalic acid, terephthalic acid, isophthalic acid, tetrabromophthalic acid and tetrachlorophthalic acid; and saturated aliphatic dicarboxylic acids such as adipic acid, azelaic acid, succinic acid, oxalic acid, suberic acid, sebacic acid, malonic acid and 1,4-cyclohexanedicarboxylic acid.

The back coat may additionally include dyes and pigments for coloration; any of the following to improve adhesion to the support: silane coupling agents, diazo resins composed of diazonium salts, organophosphonic acids, organophosphoric acids, cationic polymers; and the following substances which are commonly used as slip agents: waxes, higher aliphatic acids, higher aliphatic acid amides, silicone compounds made of dimethylsiloxane, modified dimethylsiloxane and polyethylene powder.

The back coat should have a thickness which is of a degree that will help protect the recording layer to be described below from scuffing, even in the absence of a slip sheet. A thickness of 0.01 to 8 μm is preferred. At a thickness of less than 0.01 μm, it may be difficult to prevent scuffing of the recording layer when a plurality of presensitized plates are stacked and handled together. On the other hand, at a thickness of more than 8 μm, the chemicals used in the vicinity of the lithographic printing plate during printing may cause the back coat to swell and fluctuate in thickness, altering the printing pressure and thereby compromising the printability.

Various methods may be used to provide the back coat on the back side of the support. One method involves preparing the above-mentioned back coat ingredients as a solution in a suitable solvent and applying the solution, or preparing these ingredients as an emulsified dispersion and applying the dispersion, then drying the applied solution or dispersion. Another method involves laminating a preformed film to the support using an adhesive or heat. Yet another method involves using a melt extruder to form a molten film, then laminating the film onto the support. Still another method, which is especially preferred for achieving a suitable thickness, involves dissolving the back coat-forming ingredients in a suitable solvent, followed by application of the solution and drying. Organic solvents such as those mentioned in JP 62-251739 A may be used singly or in admixture as the media in these methods.

During production of the presensitized plate, it is possible to first provide either the back coat on the back side of the support or to first provide the recording layer on the front side of the support. Alternatively, both may be provided at the same time.

Image Recording Layer:

The presensitized plate of the invention is obtained by providing, on a support for a lithographic printing plate obtained as described above, an image recording layer which includes an infrared absorber (A), a polymerization initiator (B) and a polymerizable compound (C), and which can be removed with printing ink and/or dampening water.

Infrared Absorber (A):

The infrared absorber (A) is included in the image recording layer to enable imaging to be efficiently carried out using as the light source a laser which emits infrared light having a wavelength of 760 to 1200 nm. The function of the infrared absorber is to convert infrared light that has been absorbed into heat. The heat generated at this time thermally decomposes the polymerization initiator (radical generator) (B) described below, generating radicals. The infrared absorber (A) used in this invention is a dye or pigment having an absorption maximum in a wavelength range of 760 to 1200 nm.

Dyes which may be used include commercial dyes and known dyes that are mentioned in the technical literature, such as Senryo Benran [Handbook of Dyes] (The Society of Synthetic Organic Chemistry, Japan, 1970). Suitable dyes include azo dyes, metal complex azo dyes, pyrazolone azo dyes, naphthoquinone dyes, anthraquinone dyes, phthalocyanine dyes, carbonium dyes, quinoneimine dyes, methine dyes, cyanine dyes, squarylium dyes, pyrylium salts, metal-thiolate complexes, oxonol dyes, diimonium dyes, aminium dyes and croconium dyes.

Preferred dyes include the cyanine dyes mentioned in JP 58-125246 A, JP 59-84356 A, JP 59-202829 A and JP 60-78787 A; the methine dyes mentioned in JP 58-173696 A, JP 58-181690 A and JP 58-194595 A; the naphthoquinone dyes mentioned in JP 58-112793 A, JP 58-224793 A, JP 59-48187 A, JP 59-73996 A, JP 60-52940 A and JP 60-63744 A; the squarylium dyes mentioned in JP 58-112792 A; and the cyanine dyes mentioned in GB 434,875 B.

The near-infrared absorbing sensitizers mentioned in U.S. Pat. No. 5,156,938 can also be advantageously used. Other compounds that are suitable for use in this way include the substituted arylbenzo(thio)pyrylium salts mentioned in U.S. Pat. No. 3,881,924; the trimethinethiapyrylium salts mentioned in JP 57-142645 A (U.S. Pat. No. 4,327,169), the pyrylium compounds mentioned in JP 58-181051 A, JP 58-220143 A, JP 59-41363 A, JP 59-84248 A, JP 59-84249 A, JP 59-146063 A and JP 59-146061 A; the cyanine dyes mentioned in JP 59-216146 A; the pentamethinethiopyrylium salts mentioned in U.S. Pat. No. 4,283,475; and the pyrylium compounds mentioned in JP 5-13514 B and JP 5-19702 B.

Additional suitable examples include the near-infrared absorbing dyes of formulas (I) and (II) in U.S. Pat. No. 4,756,993, and the specific indolenine cyanine dyes mentioned in JP 2002-278057 A.

Especially suitable examples of these dyes include cyanine dyes, squarylium dyes, pyrylium salts, nickel-thiolate complexes and indolinine cyanine dyes. Of these, cyanine dyes and indolenine cyanine dyes are preferred, and cyanine dyes of general formula (i) below are especially preferred.

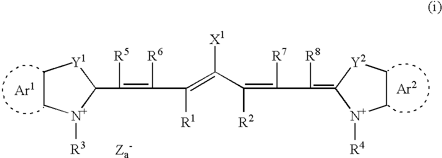

In general formula (i), X¹ is a hydrogen atom, a halogen atom, —NPh₂ (where “Ph” represents a phenyl group), —X²-L or a group of the following formula.

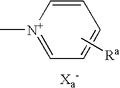

In the above formulas, X² is an oxygen atom, a nitrogen atom or a sulfur atom; L¹ is a hydrocarbon group of 1 to 12 carbons, an aromatic ring having a heteroatom, or a hydrocarbon group of 1 to 12 carbons having a heteroatom. “Heteroatom,” as used herein, refers to a nitrogen, sulfur, oxygen, halogen or selenium atom.

Xₐ⁻ is defined in the same way as Zₐ⁻ described below; and R^{a} represents a substituent selected from among hydrogen atoms, alkyl groups, aryl groups, substituted or unsubstituted amino groups and halogen atoms.

R¹ and R² are each independently a hydrocarbon group of 1 to 12 carbons. For good shelf stability of the image recording layer-forming coating fluid, it is preferable for R¹ and R² each to be a hydrocarbon group having at least two carbons. It is even more preferable for R¹ and R² to be bonded to each other so as to form a 5- or 6-membered ring.

Ar¹ and Ar² are each independently an aromatic hydrocarbon group that may be substituted. Preferred aromatic hydrocarbon groups include benzene rings and naphthalene rings. Preferred substituents include hydrocarbon groups of up to 12 carbons, halogen atoms, and alkoxy groups of up to 12 carbons.

Y¹ and Y² are each independently a sulfur atom or a dialkylmethylene group of up to 12 carbons.

R³ and R⁴ are each independently a hydrocarbon group of up to 20 carbons which may be substituted. Preferred substituents include alkoxy groups of up to 12 carbons, carboxyl groups and sulfo groups.

R⁵ to R⁸ are each independently a hydrogen atom or a hydrocarbon group of up to 12 carbons. For reasons having to do with the availability of the starting materials, it is preferable for each of R⁵ to R⁸ to be a hydrogen atom.

Zₐ⁻ represents a counteranion. In cases where the cyanine dye of general formula (i) has an anionic substituent within the structure and there is no need for charge neutralization, Zₐ⁻ is unnecessary. For good shelf stability of the image recording layer-forming coating fluid, preferred examples of Zₐ⁻ include halide ions, perchlorate ions, tetrafluoroborate ions, hexafluorophosphate ions and sulfonate ions. Of these, perchlorate ions, hexafluorophosphate ions and arylsulfonate ions are preferred.

Specific examples of cyanine dyes of general formula (i) that may -be preferably used in the invention include those described in Paragraphs [0017] to [0019] of JP 2001-133969 A.

Other especially preferred examples include the specific indolenine cyanine dyes mentioned in JP 2002-278057 A.

Pigments which may be used include commercial pigments and pigments mentioned in the technical literature, such as the Colour Index, Saishin Ganryo Binran [Latest Handbook of Pigments] (Japan Association of Pigment Technology, 1977), Saishin Ganryo Oyo Gijutsu [Recent Pigment Applications Technology] (CMC Shuppan, 1986), and Insatsu Inki Gijutsu [Printing Ink Technology] (CMC Shuppan, 1984).

Suitable pigments include black pigments, yellow pigments, orange pigments, brown pigments, red pigments, purple pigments, blue pigments, green pigments, fluorescent pigments, metal powder pigments and polymer-bonded dyes. Specific examples include insoluble azo pigments, azo lake pigments, condensed azo pigments, chelate azo pigments, phthalocyanine pigments, anthraquinone pigments, perylene and perinone pigments, thioindigo pigments, quinacridone pigments, dioxazine pigments, isoindolinone pigments, quinophthalone pigments, lake pigments, azine pigments, nitroso pigments, nitro pigments, natural pigments, fluorescent pigments, inorganic pigments and carbon black. Of these, carbon black is preferred.

The pigments may be used without being surface treated or may be used after surface treatment. Examples of surface treatment methods include surface coating with a resin or wax, surfactant deposition, and bonding a reactive substance (e.g., a silane coupling agent, an epoxy compound or a polyisocyanate) to the pigment surface. Surface treatment methods that may be used include those described in Kinzoku Sekken no Seishitsu to Oyo [Properties and Applications of Metallic Soaps] (Koshobo), Insatsu Inki Gijutsu [Printing Ink Technology] (CMC Shuppan, 1984), and Saishin Ganryo Oyo Gijutsu [Recent Pigment Applications Technology] (CMC Shuppan, 1986).

The pigment has a particle size which is in a range of preferably 0.01 to 10 μm, more preferably 0.05 to 1 μm, and even more preferably 0.1 to 1 μm. Within the above range, the pigment dispersion has a good stability in the image recording layer-forming coating fluid, and an image recording layer of a good uniformity can be achieved.

Known dispersion techniques such as those which can be used in ink production or toner production may be employed as the pigment dispersing method. Illustrative examples of equipment that may be used for this purpose include ultrasonic dispersers, sand mills, attritors, pearl mills, super mills, ball mills, impellers, dispersers, KD mills, colloid mills, dynatron mills, three-roll mills and pressure kneaders. Detailed descriptions are given in Saishin Ganryo Oyo Gijutsu [Recent Pigment Applications Technology] (CMC Shuppan, 1986).

A single infrared absorber (A) may be used alone, or two or more may be used together.

The infrared absorber (A) is used in an amount, based on the total solids in the image recording layer, of preferably 1 to 5 wt %, more preferably 1 to 4 wt %, and even more preferably 1 to 3 wt %. Within the above range, a good sensitivity can be obtained.

Polymerization Initiator (B):

The polymerization initiator (B) generates radicals under the effect of heat, light or both forms of energy, thereby initiating and accelerating polymerization of the subsequently described polymerizable compound (C). Thermally degradable radical generators which decompose under the effect of heat to generate a radical are useful as the polymerization initiator (B). When such a radical generator is used together with the above-described infrared absorber (A), irradiation with an infrared laser causes the infrared absorber (A) to generate heat, which heat in turn generates radicals. The combination of these compounds thus enables heat mode recording to occur.

Exemplary radical generators include onium salts, trihalomethyl group-bearing triazine compounds, peroxides, azo-type polymerization initiators, azide compounds and quinonediazide compounds. Of these, onium salts are especially preferred on account of their high sensitivity.

Preferred onium salts include iodonium salts, diazonium salts and sulfonium salts. Especially preferred onium salts include those of general formulas (I) to (III) below.

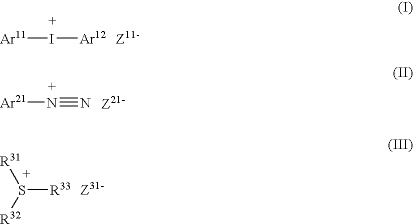

In general formula (I), Ar¹¹ and Ar¹² are each independently an aryl group of up to 20 carbons which may have substituents. Preferred substituents include halogen atoms, nitro, alkyl groups of up to 12 carbons, alkoxy groups of up to 12 carbons, and aryloxy groups of up to 12 carbons.

Z¹¹⁻ is a counterion selected from the group consisting of halide ions, perchlorate ions, tetrafluoroborate ions, hexafluorophosphate ions, carboxylate ions and sulfonate ions. Of these, perchlorate ions, hexafluorophosphate ions, carboxylate ions and arylsulfonate ions are preferred.

In general formula (II), Ar²¹ is an aryl group of up to 20 carbons which may have substituents. Preferred substituents include halogen atoms, nitrob group, alkyl groups of up to 12 carbons, alkoxy groups of up to 12 carbons, aryloxy groups of up to 12 carbons, alkylamino groups of up to 12 carbons, dialkylamino groups of up to 12 carbons, arylamino groups of up to 12 carbons and diarylamino groups of up to 12 carbons.

Z²¹⁻ is the same as Z¹¹⁻ in general formula (I) above.

In general formula (III), R³¹ to R³³ are each independently a hydrocarbon group of up to 20 carbons which may have substituents. Preferred substituents include halogen atoms, nitro group, alkyl groups of up to 12 carbons, alkoxy groups of up to 12 carbons, and aryloxy groups of up to 12 carbons.

Z³¹⁻ is the same as Z²¹⁻ in general formula (I) above.

Specific examples are given below of the onium salts of above general formula (I) (OI-1 to OI-10), the onium salts of above general formula (II) (ON-1 to ON-5) and the onium salts of above general formula (III) (OS-1 to OS-10).

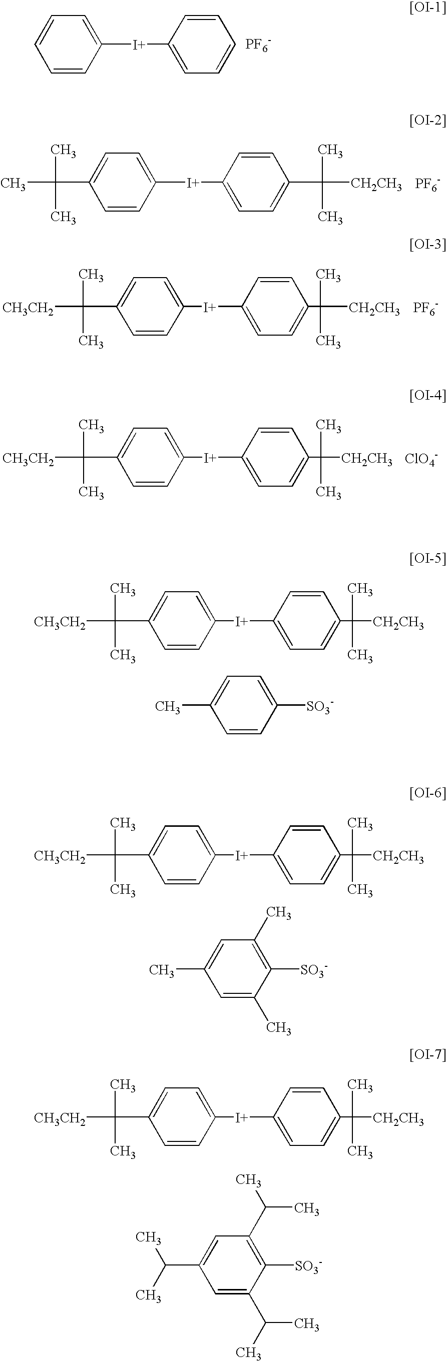

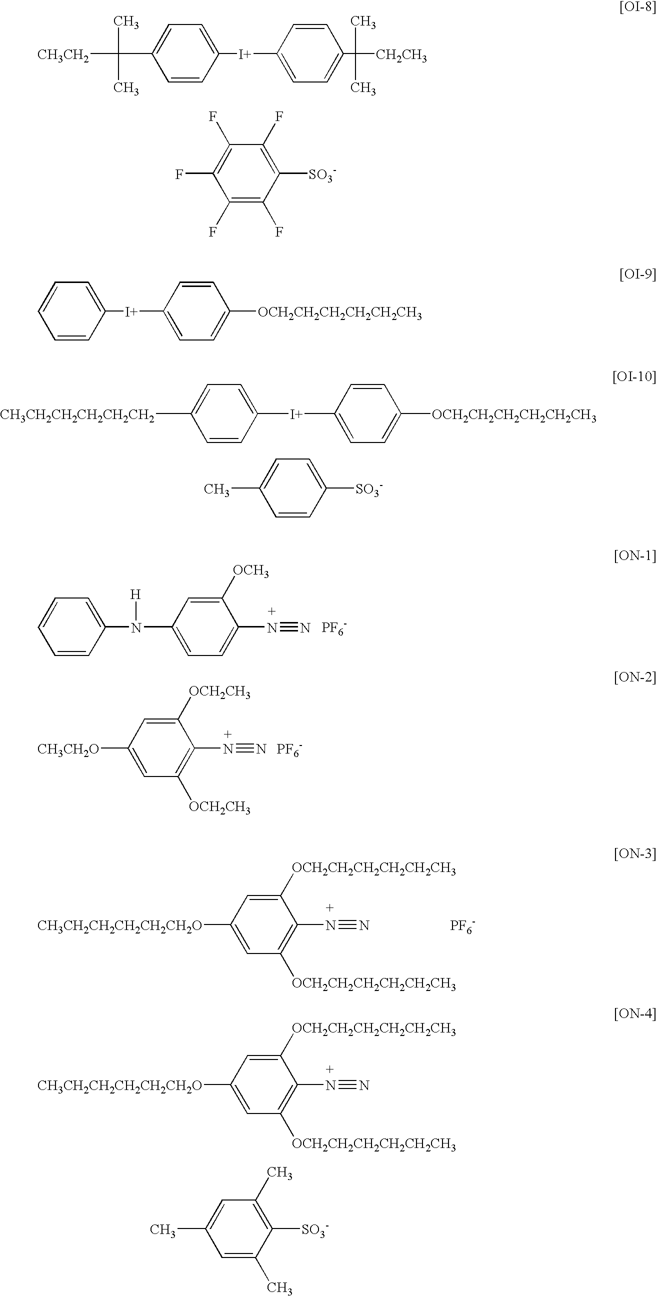

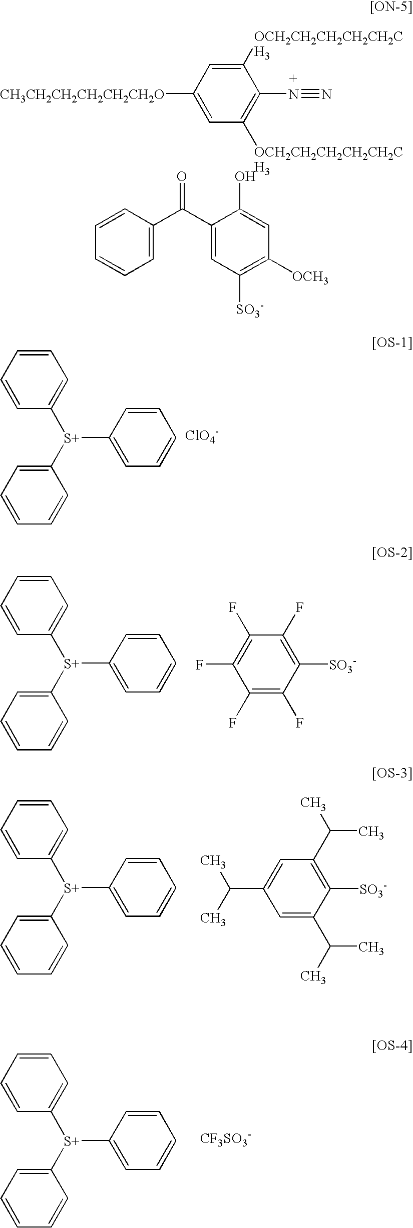

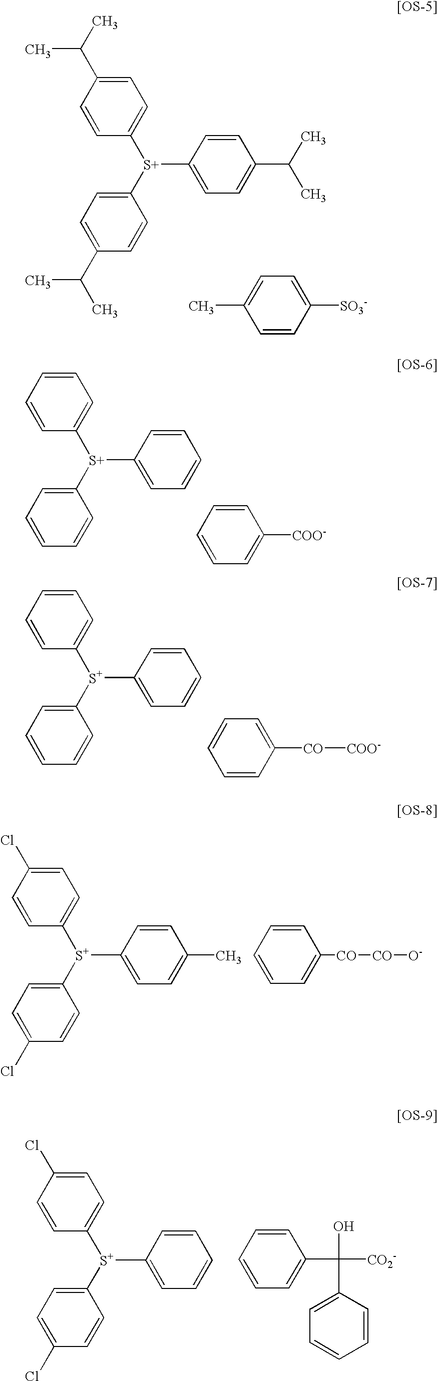

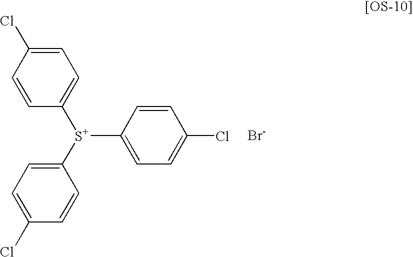

Specific examples of onium salts that can be advantageously used as the radical generator in the practice of the invention include those mentioned in JP 2001-133969 A, JP 2001-343742 A and JP 2002-148790 A.

In the invention, these onium salts function not as an acid generator, but rather as an initiator for radical polymerization.

The radical generator used in the invention has a maximum absorption wavelength of preferably not more than 400 nm, more preferably not more than 360 nm, and even more preferably not more than 300 nm. By having the absorption wavelength fall within the ultraviolet range in this way, the presensitized plate can be handled under a white light.

A single polymerization initiator (B) may be used alone, or two or more may be used together.

In the image recording layer, the polymerization initiator (B) is used in a weight ratio with respect to the infrared absorber (A) of preferably at least 5, but preferably not more than 10, and more preferably not more than 8. Within this range, a good sensitivity and press life can be obtained. If the weight ratio of the polymerization initiator (B) relative to the infrared absorber (A) is too small, a polymerization efficiency that overcomes the polymerization inhibiting effect of the infrared absorber (A) is not achieved. On the other hand, if the weight ratio of the polymerization initiator (B) relative to the infrared absorber (A) is too large, undesirable effects such as precipitation of the polymerization initiator (B) within the image recording layer tend to arise.

The content of polymerization initiator (B), based on the total solids in the image recording layer, is preferably 0.1 to 50 wt %, more preferably 0.5 to 30 wt %, and most preferably 1 to 20 wt %. Within this range, there can be obtained a good image recording layer sensitivity and good scumming resistance at non-image areas during printing.

In the image recording layer, the polymerization initiator (B) may be added to the same layer as the other components, or it may be added to a different, separately provided layer such as an overcoat layer.

Polymerizable Compound (C):

The radical polymerizable compound (C) is a radical polymerizable compound having at least one ethylenically unsaturated double bond, and is selected from among compounds having at least one, and preferably two or more, terminal ethylenically unsaturated bonds. Such compounds are widely used in industrial fields related to the present invention, and may be used herein without any particular limitation. These compounds have a variety of chemical forms, including monomers and prepolymers (e.g., dimers, trimers, and oligomers), as well as mixtures and copolymers thereof.

Examples of such monomers and their copolymers include unsaturated carboxylic acids (e.g., acrylic acid, methacrylic acid, itaconic acid, crotonic acid, isocrotonic acid, maleic acid), and their esters and amides. Preferred examples include esters of unsaturated carboxylic acids and aliphatic polyols, and amides of unsaturated carboxylic acids and aliphatic polyamines.

Preferred use can also be made of the addition reaction products of unsaturated carboxylic acid esters or amides having nucleophilic substituents such as hydroxy group, amino group and mercapto group with monofunctional or polyfunctional isocyanates or epoxy compounds, or of the dehydration condensation reaction products of similarly substituted unsaturated carboxylic acid esters or amides with monofunctional or polyfunctional carboxylic acids. The addition reaction products of unsaturated carboxylic acid esters or amides having electrophilic substituents such as isocyanate group or epoxy group with monofunctional or polyfunctional alcohols, amines or thiols; and the substitution reaction products of unsaturated carboxylic acid esters or amides having eliminable substituents such as halogens or tosyloxy group with monofunctional or polyfunctional alcohols, amines or thiols are also preferred. To cite further examples, use can also be made of the group of compounds in which the unsaturated carboxylic acid mentioned above has been replaced with, for example, an unsaturated phosphonic acid, styrene or vinyl ether.

Specific examples of the esters of unsaturated carboxylic acids and aliphatic polyols are given below.

Acrylic acid esters include ethylene glycol diacrylate, triethylene glycol diacrylate, 1,3-butanediol diacrylate, tetramethylene glycol diacrylate, propylene glycol diacrylate, neopentyl glycol diacrylate, trimethylolpropane triacrylate, trimethylolpropane tri(acryloyloxypropyl) ether, trimethylolethane triacrylate, hexanediol diacrylate, 1,4-cyclohexanediol diacrylate, tetraethylene glycol diacrylate, pentaerythritol diacrylate, pentaerythritol triacrylate, pentaerythritol tetraacrylate, dipentaerythritol diacrylate, dipentaerythritol hexaacrylate, sorbitol triacrylate, sorbitol tetraacrylate, sorbitol pentaacrylate, sorbitol hexaacrylate, tri(acryloyloxyethyl) isocyanurate and polyester acrylate oligomers.

Methacrylic acid esters include tetramethylene glycol dimethacrylate, triethylene glycol dimethacrylate, neopentyl glycol dimethacrylate, trimethylolpropane trimethacrylate, trimethylolethane trimethacrylate, ethylene glycol dimethacrylate, 1,3-butanediol dimethacrylate, hexanediol dimethacrylate, pentaerythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, bis[p-(3-methacryloxy-2-hydroxypropoxy)phenyl]dimethylmethane and bis[p-(methacryloxyethoxy)phenyl]dimethylmethane.

Itaconic acid esters include ethylene glycol diitaconate, propylene glycol diitaconate, 1,3-butanediol diitaconate, 1,4-butanediol diitaconate, tetramethylene glycol diitaconate, pentaerythritol diitaconate and sorbitol tetraitaconate.

Crotonic acid esters include ethylene glycol dicrotonate, tetramethylene glycol dicrotonate, pentaerythritol dicrotonate and sorbitol tetradicrotonate.

Isocrotonic acid esters include ethylene glycol diisocrotonate, pentaerythritol diisocrotonate and sorbitol tetraisocrotonate.

Maleic acid esters include ethylene glycol dimaleate, triethylene glycol dimaleate, pentaerythritol dimaleate and sorbitol tetramaleate.

Preferred examples of other suitable esters include the aliphatic alcohol esters mentioned in JP 46-27926 B, JP 51-47334 B and JP 57-196231 A; esters having aromatic skeletons such as those mentioned in JP 59-5240 A, JP 59-5241 A and JP 2-226149 A; and the amino group-bearing esters mentioned in JP 1-165613 A.

Specific examples of amides of unsaturated carboxylic acids with aliphatic polyamines that may be used as monomers include methylenebisacrylamide, methylenebismethacrylamide, 1,6-hexamethylenebisacrylamide, 1,6-hexamethylenebismethacrylamide, diethylenetriaminetrisacrylamide, xylylenebisacrylamide and xylylenebismethacrylamide.

Other suitable amide-type monomers include those with a cyclohexylene structure that are mentioned in JP 54-21726 B.

Urethane-type addition polymerizable compounds prepared using an addition reaction between an isocyanate group and a hydroxyl group are also preferred. Specific examples include the vinylurethane compounds having two or more polymerizable vinyl groups per molecule which are mentioned in JP 48-41708 B and are obtained by adding a hydroxyl group-bearing vinyl monomer of formula (IV) below to a polyisocyanate compound having at least two isocyanate groups per molecule.
CH₂═C(R⁴¹)COOCH₂CH(R⁴²)OH (IV)
In formula (IV), R⁴¹ and R⁴² each independently represent —H or —CH₃.

Urethane acrylates such as those mentioned in JP 51-37193 A, JP 2-32293 B and JP 2-16765 B, and the urethane compounds having an ethylene oxide-type skeleton mentioned in JP 58-49860 B, JP 56-17654 B, JP 62-39417 B and JP 62-39418 B are also preferred.

Other preferred examples include the radical polymerizable compounds having within the molecule an amino structure or a sulfide structure that are mentioned in JP 63-277653 A, JP 63-260909 A and JP 1-105238 A. Photopolymerizable compositions of exceptional sensitivity (speed) can be obtained with this.

Additional examples include polyfunctional acrylates and methacrylates, including polyester acrylates, and epoxy acrylates obtained by reacting an epoxy resin with (meth)acrylic acid, such as those mentioned in JP 48-64183 A, JP 49-43191 B and JP 52-30490 B.

Further examples include the specific unsaturated compounds mentioned in JP 46-43946 B, JP 1-40337 B and JP 1-40336 B, and the vinylphosphonic acid compounds mentioned in JP 2-25493 A.

In some cases, it will be desirable to use the perfluoroalkyl group-containing structures mentioned in JP 61-22048 A.

Use can also be made of the photocurable monomers and oligomers mentioned in Nippon Setchaku Kyokaishi, Vol. 20, No. 7, 300-308 (1984).

Details concerning use of the polymerizable compound (C), such as what type of structure it should have, whether to use one such compound alone or a combination of two or more thereof, and the amount of addition can be selected as desired in accordance with the performance characteristics intended for the recording material. For example, selection can be made based on the following considerations.

For good sensitivity, a structure having a high unsaturated group content per molecule is preferred. In most cases, a functionality of at least two is preferred. Moreover, to increase the strength of the image areas (i.e., the cured film), a functionality of three or more is desirable. Also effective are methods in which both the photosensitivity and strength are adjusted by using compounds having differing numbers of functional groups or differing polymerizable groups (e.g., acrylic acid esters, methacrylic acid esters, styrene compounds, vinyl ether compounds) in combination. Compounds of a large molecular weight and compounds of a high hydrophobicity provide an excellent sensitivity and film strength, but may be undesirable because of their poor on-machine developability. -Selection of the polymerizable compound (C) and how it is used are also important factors affecting both the compatibility of the compound with other ingredients within the image recording layer (e.g., binder polymer, initiator, colorant) and its dispersibility. For instance, the compatibility can be enhanced by using a low-purity compound or by using two or more polymerizable compounds together. It is also possible to select a specific structure so as to enhance adhesion with the support or the overcoat layer.

In light of the above, it is usually preferable for the proportion of the polymerizable compound (C) to be within a range of 5 to 80 wt %, and especially 20 to 75 wt %, based on the total solids in the image recording layer. Such compounds may be used singly or as combinations of two or more thereof. With regard to the manner in which the polymerizable compound (C) is used, any suitable structure, formulation and amount of addition may be selected based on such considerations as the degree to which polymerization is inhibited by oxygen, the desired resolution of the printing plate, the tendency for fogging, changes in refractive index, and surface tackiness. In some cases, a layered construction that includes an undercoat and an overcoat, and corresponding methods of application, may be employed.

Binder Polymer:

In the practice of the invention, a binder polymer can additionally be used for such purposes as enhancing the film-forming properties of the image recording layer and improving the on-machine developability. The use of a linear organic polymer as the binder polymer is preferred from the standpoint of film formability. Known linear organic polymers may be used for this purpose. Illustrative examples include acrylic resins, polyvinylacetal resins, polyurethane resins, polyurea resins, polyimide resins, polyamide resins, epoxy resins, methacrylic resins, polystyrene resins, novolak-type phenolic resins, polyester resins, synthetic rubbers and natural rubbers.

To enhance the film strength in image areas, the binder polymer preferably has crosslinkability. To confer the binder polymer with crosslinkability, crosslinkable functional groups such as ethylenically unsaturated bonds may be introduced onto the polymer backbone or side chains. Crosslinkable functional groups may be introduced by copolymerization or by a polymer reaction.

Illustrative examples of polymers having ethylenically unsaturated bonds on the backbone of the molecule include poly-1,4-butadiene and poly-1,4-isoprene.

Examples of polymers having ethylenically unsaturated bonds on side chains of the molecule include polymers of acrylic acid or methacrylic acid esters or amides, in which polymers at least some of the ester or amide residues (the “R” in —COOR or —CONHR) have an ethylenically unsaturated bond.

Exemplary residues (the above-mentioned “R”) having ethylenically unsaturated bonds include —(CH₂)ₙCR¹═CR²R³, —(CH₂O)ₙCH₂CR¹═CR²R³, —(CH₂CH₂O)ₙCH₂CR¹═CR²R³, —(CH₂)ₙNH—CO—O—CH₂CR¹═CR²R³, —(CH₂)ₙ—O—CO—CR¹═CR²R³ and —(CH₂CH₂O)₂—X (wherein R¹ to R³ each represents a hydrogen atom, a halogen atom, or an alkyl, aryl, alkoxy or aryloxy group of 1 to 20 carbons, and R¹ may bond together with R² or R³ to form a ring; the letter n is an integer from 1 to 10; and X is a dicyclopentadienyl residue).

Specific examples of suitable ester residues include —CH₂CH═CH₂, —CH₂CH₂O—CH₂CH═CH₂, —CH₂C(CH₃)═CH₂, —CH₂CH═CH—C₆H₅, —CH₂CH₂OCOCH═CH—C₆H₅, —CH₂CH₂OCOC(CH₃)═CH₂, —CH₂CH₂OCOCH═CH₂, —CH₂CH₂—NHCOO—CH₂CH═CH₂ and —CH₂CH₂O—X (wherein X is a dicyclopentadienyl residue).

Specific examples of suitable amide residues include —CH₂CH═CH₂, —CH₂CH₂—Y (wherein Y is a cyclohexene residue) and —CH₂CH₂—OCO—CH═CH₂.

The binder polymer having crosslinkability is cured by, for example, the addition of free radicals (polymerization initiating radicals, or propagation radicals during polymerization of the polymerizable compound) to the crosslinkable functional groups on the polymer to effect addition polymerization, either directly between polymers or via chain polymerization of the polymerizable compounds. Alternatively, the binder polymer having crosslinkability is cured when atoms on the polymer (e.g., hydrogen atoms on carbon atoms adjacent to the crosslinkable functional groups) are pulled off by free radicals, thereby forming polymer radicals which bond to each other, resulting in the formation of crosslinks between the polymer molecules.

The content of the crosslinkable groups in the binder polymer (content of radical-polymerizable unsaturated double bonds, as determined by iodine titration) is preferably 0.1 to 10.0 mmol, more preferably 1.0 to 7.0 mmol, and most preferably 2.0 to 5.5 mmol, per gram of the binder polymer. The sensitivity of the image recording layer and the shelf stability of the image recording layer-forming coating liquid are particularly good within this range.

For improved on-machine development of unexposed areas of the image recording layer, it is preferable for the binder polymer to have a high solubility or dispersibility in printing ink and/or dampening water.

To improve solubility or dispersibility in printing ink, it is preferable for the binder polymer to be oleophilic. To improve solubility or dispersibility in dampening water, it is preferable for the binder polymer to be hydrophilic. Hence, in the practice of the invention, it is effective to use both an oleophilic binder polymer and a hydrophilic binder polymer.

The hydrophilic binder polymer is preferably one which includes hydrophilic groups such as hydroxyl, carboxyl, carboxylate, hydroxyethyl, polyoxyethyl, hydroxypropyl, polyoxypropyl, amino, aminoethyl, aminopropyl, ammonium, amide, carboxymethyl, sulfonic acid and phosphoric acid groups.

Specific examples of such binders include gum arabic, casein, gelatin, starch derivatives, carboxymethyl cellulose and its sodium salt, cellulose acetate, sodium alginate, vinyl acetate-maleic acid copolymers, styrene-maleic acid copolymers, polyacrylic acids and their salts, polymethacrylic acids and their salts, homopolymers and copolymers of hydroxyethyl methacrylate, homopolymers and copolymers of hydroxyethyl acrylate, homopolymers and copolymers of hydroxypropyl methacrylate, homopolymers and copolymers of hydroxypropyl acrylate, homopolymers and copolymers of hydroxybutyl methacrylate, homopolymers and copolymers of hydroxybutyl acrylate, polyethylene glycols, hydroxypropylene polymers, polyvinyl alcohols, hydrolyzed polyvinyl acetates having a degree of hydrolysis of at least 60 wt %, and preferably at least 80 wt %, polyvinyl formal, polyvinyl butyral, polyvinyl pyrrolidone, acrylamide homopolymers and copolymers, methacrylamide homopolymers and copolymers, N-methylolacrylamide homopolymers and copolymers, polyvinylpyrrolidones, alcohol-soluble nylons, and polyethers of 2,2-bis(4-hydroxyphenyl)propane with epichlorohydrin.

The binder polymer has a weight-average molecular weight of preferably at least 5,000, and more preferably from 10,000 to 300,000, and has a number-average molecular weight of preferably at least 1,000, and more preferably from 2,000 to 250,000. The polydispersity (weight-average molecular weight/number-average molecular weight) is preferably from 1.1 to 10.

The binder polymer may be a random polymer, a block polymer a graft polymer or the like. A random polymer is preferred.

The binder polymer can be synthesized by a known method. In particular, binder polymers having crosslinkable groups in a side chain can easily be synthesized by radical polymerization or by a polymer reaction

Radical polymerization initiators that may be used in radical polymerization include known compounds such as azo initiators and peroxide initiators. Examples of solvents that may be used during synthesis include tetrahydrofuran, ethylene dichloride, cyclohexanone, methyl ethyl ketone, acetone, methanol, ethanol, ethylene glycol monomethyl ether, ethylene glycol monoethyl ether, 2-methoxyethyl acetate, diethylene glycol dimethyl ether, 1-methoxy-2-propanol, 1-methoxy-2-propyl acetate, N,N-dimethylformamide, N,N-dimethylacetamide, toluene, ethyl acetate, methyl lactate, ethyl lactate, dimethyl sulfoxide and water. These may be used singly or as mixtures of two or more thereof.

The binder polymer may be used singly or as a mixture of two or more thereof. The binder polymer content is preferably 10 to 90 wt %, more preferably 20 to 80 wt %, and even more preferably 30 to 70 wt %, based on the total solids in the image recording layer. A content within this range provides an image area strength and image forming properties which are particularly good.

It is preferable to use the polymerizable compound (C) and the binder polymer in a weight ratio of 1/9 to 7/3.

Surfactant:

To promote the on-machine developability of the exposed plate at the start of printing and to enhance the coating surface shape, it is desirable to use a surfactant in the image recording layer. Exemplary surfactants include nonionic surfactants, anionic surfactants, cationic surfactants, amphoteric surfactants and fluorocarbon surfactants. Use may be made of a single surfactant or of a combination of two or more surfactants.

Any known nonionic surfactant may be used in the invention without particular limitation. Specific examples include polyoxyethylene alkyl ethers, polyoxyethylene alkylphenyl ethers, polyoxyethylene polystyrylphenyl ethers, polyoxyethylene polyoxypropylene alkyl ethers, partial fatty acid esters of glycerol, partial fatty acid esters of sorbitan, partial fatty acid esters of pentaerythritol, fatty acid monoesters of propylene glycol, partial fatty acid esters of sucrose, partial fatty acid esters of polyoxyethylene sorbitan, partial fatty acid esters of polyoxyethylene sorbitol, fatty acid esters of polyethylene glycol, partial fatty acid esters of polyglycerol, polyoxyethylenated castor oils, partial fatty acid esters of polyoxyethylene glycerol, fatty acid diethanolamides, N,N-bis-2-hydroxyalkylamines, polyoxyethylene alkyl amines, fatty acid esters of triethanolamine, trialkylamine oxides, polyethylene glycol, and copolymers of polyethylene glycol and polypropylene glycol.

Any known anionic surfactant may be used in the invention without particular limitation. Specific examples include fatty acid salts, abietic acid salts, hydroxyalkanesulfonates, alkanesulfonates, dialkylsulfosuccinates, straight-chain alkylbenzenesulfonates, branched-chain alkylbenzenesulfonates, alkylnaphthalenesulfonates, alkylphenoxypolyoxyethylene propylsulfonates, polyoxyethylene alkylsulfophenyl ether salts, sodium N-methyl-N-oleyltaurate, the disodium salts of N-alkylsulfosuccinic acid monoamides, petroleum sulfonates, sulfated tallow oil, the sulfate esters of fatty acid alkyl esters, alkyl sulfates, polyoxyethylene alkyl ether sulfates, fatty acid monoglyceride sulfates, polyoxyethylene alkylphenyl ether sulfates, polyoxyethylene styrylphenyl ether sulfates, alkyl phosphates, polyoxyethylene alkyl ether phosphates, polyoxyethylene alkylphenyl ether phosphates, partially saponified styrene-maleic anhydride copolymers, partially saponified olefin-maleic anhydride copolymers and naphthalenesulfonic acid-formalin condensates.

Any known cationic surfactant may be used in the invention without particular limitation. Examples include alkylamine salts, quaternary ammonium salts, polyoxyethylene alkylamine salts and polyethylene polyamine derivatives.

Any known amphoteric surfactant may be used in the invention without particular limitation. Examples include carboxybetaines, aminocarboxylic acids, sulfobetaines, aminosulfates and imidazolines.

In the surfactants mentioned above, the term “polyoxyethylene” may be substituted with the more general term “polyoxyalkylene,” additional examples of which include polyoxymethylene, polyoxypropylene and polyoxybutylene. Surfactants containing these latter pol-yoxyalkylene groups can likewise be used in the present invention.

Even more preferable surfactants include fluorocarbon surfactants having perfluoroalkyl groups on the molecule. Examples of such fluorocarbon surfactants include anionic surfactants such as perfluoroalkylcarboxylates, perfluoroalkylsulfonates and perfluoroalkylphosphates; amphoteric surfactants such as perfluoroalkylbetains; cationic surfactants such as perfluoroalkyltrimethylammonium salts; and nonionic surfactants such as perfluoroalkylamine oxides, perfluoroalkyl-ethylene oxide adducts, oligomers containing perfluoroalkyl groups and hydrophilic groups, oligomers containing perfluoroalkyl groups and oleophilic groups, oligomers containing perfluoroalkyl groups, hydrophilic groups and oleophilic groups, and urethanes containing perfluoroalkyl groups and oleophilic groups. Preferred examples include the fluorocarbon surfactants mentioned in JP 62-170950 A, JP 62-226143 A and JP 60-168144 A.

The surfactant may be used singly or as a combination of two or more thereof.

The surfactant content is preferably 0.001 to 10 wt %, and more preferably 0.01 to 5 wt %, based on the total solids in the image recording layer.

Colorant:

Dyes having a large absorption in the visible light range can be used as image colorants in the image recording layer. Specific examples include Oil Yellow #101, Oil Yellow #103, Oil Pink #312, Oil Green BG, Oil Blue BOS, Oil Blue #603, Oil Black BY, Oil Black BS and Oil Black T-505 (all of which are produced by Orient Chemical Industries, Ltd.); and also Victoria Pure Blue, Crystal Violet (CI 42555), Methyl Violet (CI 42535), Ethyl Violet, Rhodamine B (CI 145170B), Malachite Green (CI 42000), Methylene Blue (CI 52015), and the dyes mentioned in JP 62-293247 A. Preferred use can also be made of pigments such as phthalocyanine pigments, azo pigments, carbon black and titanium oxide.

The addition of these colorants is desirable because they enable image areas and non-image areas to be easily distinguished from each other following image formation. The amount of such addition is typically 0.01 to 10 wt %, based on the total solids in the image recording layer.

Printing-Out Agent:

An acid or radical-responsive chromogenic compound may be added to the image recording layer in order to form a print-out image. Examples of such compounds which can be effectively used for this purpose include diphenylmethane, triphenylmethane, thiazine, oxazine, xanthene, anthraquinone, iminoquinone, azo and azomethine dyes.

Specific examples include dyes such as Brilliant Green, Ethyl Violet, Methyl Green, Crystal Violet, Basic Fuchsin, Methyl Violet 2B, Quinaldine Red, Rose Bengal, Metanil Yellow, thymolsulfophthalein, Xylenol Blue, Methyl Orange, Paramethyl Red, Congo Red, Benzopurpurin 4B, a-Naphthyl Red, Nile Blue 2B, Nile Blue A, Methyl Violet, Malachite Green, Parafuchsin, Victoria Pure Blue BOH (produced by Hodogaya Chemical Co., Ltd.), Oil Blue #603 (Orient Chemical Industries, Ltd.), Oil Pink #312 (Orient Chemical Industries), Oil Red 5B (Orient Chemical Industries), Oil Scarlet #308 (Orient Chemical Industries), Oil Red OG (Orient Chemical Industries), Oil Red RR (Orient Chemical Industries), Oil Green #502 (Orient Chemical Industries), Spiron Red BEH Special (Hodogaya Chemical), m-Cresol Purple, Cresol Red, Rhodamine B, Rhodamine 6G, Sulforhodamine B, Auramine, 4-p-diethylaminophenyliminonaphthoquinone, 2-carboxyanilino -4-p-diethylaminophenyliminonaphthoquinone, 2-carboxystearylamino-4-p-N,N-bis(hydroxyethyl)aminophenyliminonaphthoquinone, 1-phenyl-3-methyl-4-p-diethylaminophenylimino-5-pyrazolone and 1-β-naphthyl -4-p-diethylaminophenylimino-5-pyrazolone; and leuco dyes such as p,p′,p″-hexamethyltriaminotriphenylmethane (Leuco Crystal Violet) and Pergascript Blue SRB (Ciba Geigy).

Aside from the above, advantageous use can also be made of leuco dyes known to be used in heat-sensitive or pressure-sensitive paper. Specific examples include Crystal Violet Lactone, Malachite Green Lactone, Benzoyl Leucomethylene Blue, 2-(N-phenyl-N-methylamino)-6-(N-p-tolyl-N-ethyl)aminofluoran, 2-anilino-3-methyl-6-(N-ethyl-p-toluidino)fluoran, 3,6-dimethoxyfluoran, 3-(N,N-diethylamino)-5-methyl-7-(N,N-dibenzylamino)fluoran, 3-(N-cyclohexyl-N-methylamino)-6-methyl-7-anilinofluoran, 3-(N,N-diethylamino)-6-methyl-7-anilinofluoran, 3-(N,N-diethylamino)-6-methyl-7-xylidinofluoran, 3-(N,N-diethylamino)-6-methyl-7-chlorofluoran, 3-(N,N-diethylamino)-6-methoxy-7-aminofluoran, 3-(N,N-diethylamino)-7-(4-chloroanilino)fluoran, 3-(N,N-diethylamino)-7-chlorofluoran, 3-(N,N-diethylamino)-7-benzylaminofluoran, 3-(N,N-diethylamino)-7,8-benzofluoran, 3-(N,N-dibutylamino)-6-methyl-7-anilinofluoran, 3-(N,N-dibutylamino)-6-methyl-7-xylidinofluoran, 3-piperidino-6-methyl-7-anilinofluoran, 3-pyridino-6-methyl-7-anilinofluoran, 3,3-bis(l-ethyl-2-methylindol-3-yl)phthalide, 3,3-bis(l-n-butyl-2-methylindol-3-yl)phthalide, 3,3-bis(p-dimethylaminophenyl)-6-dimethylaminophthalide, 3-(4-diethylamino-2-ethoxyphenyl)-3-(1-ethyl-2-methylindol-3-yl)-4-azaphthalide and 3-(4-diethylaminophenyl)-3-(1-ethyl-2-methylindol-3-yl)phthalide.

The acid or radical-responsive chromogenic dye is preferably added in a ratio of 0.01 to 10 wt %, based on the image recording layer.

Polymerization Inhibitor:

To prevent unwanted thermal polymerization of the polymerizable compound (C) during production or storage of the image recording layer, it is desirable to add a small amount of thermal polymerization inhibitor to the image recording layer.

Preferred examples of the thermal polymerization inhibitor include hydroquinone, p-methoxyphenol, di-t-butyl-p-cresol, pyrogallol, t-butylcatechol, benzoquinone, 4,4′-thiobis(3-methyl-6-t-butylphenol), 2,2′-methylenebis(4-methyl-6-t-butylphenol) and the aluminum salt of N-nitroso-N-phenylhydroxylamine.

The thermal polymerization inhibitor is added in an amount of preferably about 0.01 to about 5 wt %, based on the image recording layer.

Higher Fatty Acid Derivative and Others:

In the image recording layer of the invention, to prevent the inhibition of polymerization by oxygen, a higher fatty acid derivative or the like such as behenic acid or behenamide may be added and induced to concentrate primarily at the surface of the image recording layer as the layer dries after coating. The higher fatty acid derivative is added in an amount of preferably about 0.1 to about 10 wt %, based on the total solids in the image recording layer.

Plasticizer:

The image recording layer of the invention may also contain a plasticizer to improve the on-machine developability.

Preferred examples of the plasticizer include phthalic acid esters such as dimethyl phthalate, diethyl phthalate, dibutyl phthalate, diisobutyl phthalate, dioctyl phthalate, octylcapryl phthalate, dicyclohexyl phthalate, ditridecyl phthalate, butylbenzyl phthalate, diisodecyl phthalate and diallyl phthalate; glycol esters such as dimethyl glycol phthalate, ethyl phthalyl ethyl glycolate, methyl phthalyl ethyl glycolate, butyl phthalyl butyl glycolate, and triethylene glycol dicaprylate; phosphoric acid esters such as tricresyl phosphate and triphenyl phosphate; dibasic fatty acid esters such as diisobutyl adipate, dioctyl adipate, dimethyl sebacate, dibutyl sebacate, dioctyl azelate and dibutyl maleate; and polyglycidyl methacrylate, triethyl citrate, triacetyl glycerine and butyl laurate.

The plasticizer content is preferably not more than about 30 wt %, based on the total solids in the image recording layer.

Fine Inorganic Particles:

The image recording layer may contain fine inorganic particles to strengthen interfacial adhesion from surface graining, improve the strength of the cured film in image areas, and enhance the on-machine developability in non-image areas.

Preferred examples include finely divided silica, alumina, magnesium oxide, titanium oxide, magnesium carbonate, calcium alginate, and mixtures thereof.

The inorganic particles have an average size of preferably 5 nm to 10 μm, and more preferably 0.5 μm to 3 μm. Within this range, they disperse stably in the image recording layer, enabling the image recording layer to maintain a sufficient degree of film strength and enabling the formation of non-image areas having excellent hydrophilic properties that are not prone to scumming during printing.

Such inorganic particles are readily available as commercial products, such as in the form of colloidal silica dispersions.

The content of these fine inorganic particles is preferably not more than 20 wt %, and more preferably not more than 10 wt %, based on the total solids in the image recording layer.

Low-Molecular-Weight Hydrophilic Compound:

To improve the on-machine developability of the presensitized plate, the image recording layer may contain a hydrophilic low-molecular-weight compound. Illustrative examples of suitable hydrophilic low-molecular weight compounds include the following water-soluble organic compounds: glycols such as ethylene glycol, diethylene glycol, triethylene glycol, propylene glycol, dipropylene glycol and tripropylene glycol, as well as ether or ester derivatives thereof; polyhydroxy compounds such as glycerol and pentaerythritol; organic amines such as triethanolamine, diethanolamine and monoethanolamine, as well as salts thereof; organic sulfonic acids such as toluenesulfonic acid and benzenesulfonic acid, as well as salts thereof; organic phosphonic acids such as phenylphosphonic acid, as well as salts thereof; and organic carboxylic acids such as tartaric acid, oxalic acid, citric acid, malic acid, lactic acid, gluconic acid and amino acids, as well as salts thereof.

Additives other than the constituents described above may also be included in the image recording layer. Formation of Image Recording Layer:

In the practice of the invention, the above constituents may be incorporated into the image recording layer in any of various ways.

One way, described in JP 2002-287334 A, involves dispersing or dissolving above ingredients in a solvent to form an image recording layer-forming coating fluid. The fluid is applied onto the support and dried, thereby forming an image recording layer. This method provides a molecular dispersion-type image recording layer.

Illustrative, non-limiting examples of the solvent include ethylene dichloride, cyclohexanone, methyl ethyl ketone, methanol, ethanol, propanol, ethylene glycol monomethyl ether, 1-methoxy-2-propanol, 2-methoxyethyl acetate, 1-methoxy-2-propyl acetate, dimethoxyethane, methyl lactate, ethyl lactate, N,N-dimethylacetamide, N,N-dimethylformamide, tetramethylurea, N-methylpyrrolidone, dimethylsulfoxide, sulfolane, γ-butyrolactone, toluene, acetone and water. These may be used alone or as mixtures of two or more thereof.

The image recording layer-forming coating fluid has a solids concentration of preferably 1 to 50 wt %.

Another way, described in JP 2001-277740 A and JP 2001-277742 A, involves forming the image recording layer after encapsulating some or all of the ingredients described above within microcapsules. This method provides a microcapsule-type image recording layer. This type of image recording layer is advantageous for achieving a better on-machine developability. It is especially preferable for at least some of the infrared absorber (A), the polymerization initiator (B) and the polymerizable compound (C) to be microencapsulated.

In a microcapsule-type image recording layer, the various ingredients mentioned above may be entirely microencapsulated or portions therieof may be included outside of the microcapsules. In the microcapsule-type image recording layer, it is especially preferable for the hydrophobic components to be enclosed in the microcapsules and for the hydrophilic components to be present outside of the microcapsules. To achieve an even better on-machine developability, it is advantageous for the image recording layer to be a microcapsule-type image recording layer.

A known method may be used for microencapsulating the ingredients. Illustrative, non-limiting examples of techniques for preparing microcapsules include the methods involving the use of coacervation described in U.S. Pat. No. 2,800,457 and U.S. Pat. No. 2,800,458; the methods that rely on interfacial polymerization described in U.S. Pat. No. 3,287,154, JP 38-19574 B and JP 42-446 B; the methods involving polymer precipitation disclosed in U.S. Pat. No. 3,418,250 and U.S. Pat. No. 3,660,304; the method that uses an isocyanate polyol wall material described in U.S. Pat. No. 3,796,669; the method that uses an isocyanate wall material described in U.S. Pat. No. 3,914,511; the methods that use a urea-formaldehyde or urea formaldehyde-resorcinol wall-forming material which are described in U.S. Pat. Nos. 4,001,140, 4,087,376 and 4,089,802; the method which uses wall materials such as melamine-formaldehyde resins and hydroxycellulose that is described in U.S. Pat. No. 4,025,445; the in situ methods involving monomer polymerization that are taught in JP 36-9163 B and JP 51-9079 B; the spray drying processes described in GB 930,422 B and U.S. Pat. No. 3,111,407; and the electrolytic dispersion cooling processes described in GB 952,807 B and GB 967,074 B.

Microcapsule walls preferred for use in this invention are those which have three-dimensional crosslinkages and are solvent-swellable. Accordingly, it is preferable for the microcapsule wall material to be polyurea, polyurethane, polyester, polycarbonate, polyamide or a mixture thereof. Polyurea and polyurethane are especially preferred. The microcapsule wall may include therein a compound having a crosslinkable functional group such as an ethylenically unsaturated bond that is capable of introducing the above-described binder polymer.

The microcapsule is preferably one having an average particle size of 0.01 to 3.0 μm, more preferably 0.05 to 2.0 μm, and most preferably 0.10 to 1.0 μm. Within the above range, it is possible to obtain a good printing plate resolution and a good stability over time in the image recording layer-forming coating liquid.

It is also possible to form the image recording layer by dispersing or dissolving the same or different ingredients from those mentioned above in like or unlike solvents to prepare a plurality of image recording layer-forming coating fluids, and coating and drying these fluids a plurality of times.

Coating Method:

The coating amount (solids content) used to form the image recording layer varies depending on the intended application, although an amount of 0.3 to 3.0 g/m² is generally preferred. Within this range, a good sensitivity and an image recording layer having good film properties can be obtained.

Any of various coating methods may be used. Examples of suitable methods of coating include bar coating, spin coating, spray coating, curtain coating, dip coating, air knife coating, blade coating and roll coating.

Protective Layer:

In the presensitized plate of the invention, the image recording layer may optionally have a protective layer thereon to prevent scuffing and other damage to the image recording layer, to serve as an oxygen barrier, and to prevent ablation during high-illuminance laser exposure.

In the practice of the invention, exposure is ordinarily carried out under conditions open to the atmosphere. A protective layer prevents oxygen and low-molecular-weight compounds such as basic substances which are present in the atmosphere and would otherwise hinder the image-forming reactions triggered by light exposure within the image recording layer from entering the image recording layer, thus keeping the image-forming reactions triggered by exposure under open-air conditions from being hindered. Therefore the properties desired of the protective layer preferably include a low permeability to oxygen and such low-molecular-weight compounds, good transmittance to the light used for exposure, excellent adhesion to the image recording layer, and easy removal during on-machine development following exposure. Various protective layers endowed with such properties have been studied in the prior art and are described in detail in, for example, U.S. Pat. No. 3,458,311 and JP 55-49729 A.

Materials that may be used in the protective layer include water-soluble polymeric compounds having a relatively good crystallinity, such as polyvinyl alcohol, polyvinyl pyrrolidone, acidic celluloses, gelatin, gum arabic and polyacrylic acid. Of these, the use of polyvinyl alcohol (PVA) as the primary component provides the best results with respect to basic properties such as the oxygen barrier properties and removability of the protective layer during development. So long as the polyvinyl alcohol includes unsubstituted vinyl alcohol units which provide the protective layer with the required oxygen barrier properties and water solubility, some of the vinyl alcohol units may be substituted with esters, ethers or acetals, and the layer may include also other copolymerizable components.

It is preferable for the polyvinyl alcohol to be 71 to 100% hydrolyzed and to have a molecular weight in a range of 300 to 2,400. Specific examples of such polyvinyl alcohols include the following, all produced by Kuraray Co., Ltd.: PVA-105, PVA-110, PVA-117, PVA-117H, PVA-120, PVA-124, PVA-124H, PVA-CS, PVA-CST, PVA-HC, PVA-203, PVA-204, PVA-205, PVA-210, PVA-217, PVA-220, PVA-224, PVA-217EE, PVA-217E, PVA-220E, PVA-224E, PVA-405, PVA-420, PVA-613 and L-8.

Conditions such as the protective layer ingredients (choice of PVA, use of additives, etc.) and coating amount may be suitably selected after taking into consideration not only the oxygen barrier properties and the removability during development, but also other characteristics, including the antifogging properties, adhesion, and scuff resistance of the protective layer. In general, a higher percent hydrolysis of the PVA (i.e., a higher content of unsubstituted vinyl alcohol units in the protective layer) and a greater film thickness provides higher oxygen barrier properties, resulting in better sensitivity. Moreover, to prevent undesirable polymerization reactions from occurring during production and storage, to prevent fogging during imagewise exposure, and to prevent thick image lines and other unwanted effects, it is preferable for the oxygen permeability to be not too high. Specifically, an oxygen permeability A at 25° C. and a pressure of not more than one atmosphere such that 0.2≦A≦20 mL/m²·day is preferred.

The (co)polymer of the above-described polyvinyl alcohol (PVA) has a molecular weight in a range of preferably 2,000 to 10 million, and more preferably 20,000 to 3 million.

The protective layer may include other ingredients such as glycerol and dipropylene glycol in an amount corresponding to several weight percent based on the (co)polymer. The presence of such ingredients enhances the flexibility.

In addition, several weight percent, based on the (co)polymer, of anionic surfactants such as sodium alkylsulfates and sodium alkylsulfonates; amphoteric surfactants such as alkyl aminocarboxylates and alkyl aminodicarboxylates; and nonionic surfactants such as polyoxyethylene alkyl phenyl ethers may be added.

The protective layer has a film thickness of preferably 0.1 to 5 μm, and more preferably 0.2 to 2 μm.

Other properties, including adhesion of the protective layer to image areas and scuff resistance, are also very important in the handling of the presensitized plate. That is, when the protective layer which is hydrophilic because it contains a water-soluble polymeric compound is laminated onto the oleophilic image recording layer, the protective layer has a tendency to delaminate owing to out-of-contact defects. In areas of delamination, defects such as poor curing of the film arise due to the inhibition of polymerization by oxygen.

Various means have been devised for improving adhesion between the image recording layer and the protective layer. For example, JP 49-70702 A and GB 1,303,578 B mention that sufficient adhesion can be achieved by mixing 20 to 60 wt % of an acrylic emulsion or a water-insoluble vinyl pyrrolidone-vinyl acetate copolymer into a hydrophilic polymer composed primarily of polyvinyl alcohol, and laminating the resulting mixture as a film onto the image recording layer. Any such known art may be employed for this purpose when working the present invention. Specific examples of methods that may be used to apply the protective layer are described in U.S. Pat. No. 3,458,311 and JP 55-49729 A.

Other functions may also be imparted to the protective layer. For example, by adding a colorant (e.g., a water-soluble dye) which has an excellent transmittance to the infrared light used for exposure and can efficiently absorb light of other wavelengths, the amenability of the presensitized plate to handling under a safelight can be improved without lowering sensitivity.

In the presensitized plate of the invention obtained in this way, the anodized layer after the image recording layer has been provided on the support has a fracture plane in which the atomic ratio of carbon to aluminum (C/Al) expressed by formula (1) below is preferably at most 1.0.
C/Al=(I_{c}/S_{c})/(Iₐₗ/Sₐₗ) (1).
In formula (1),
I_{c} is the carbon (KLL) Auger electron differential peak-to-peak intensity;
Iₐₗ is the aluminum (KLL) Auger electron differential peak-to-peak intensity;
S_{c} is the carbon (KLL) Auger electron relative sensitivity factor; and
Sₐₗ is the aluminum (KLL) Auger electron relative sensitivity factor.

The method of calculating the carbon-to-aluminum atomic ratio (C/Al) is described more fully here while referring to FIG. 1.

FIG. 1 is an example of a chart such as may be obtained by carrying out an Auger electron spectroscopic analysis of the fracture plane of the anodized layer on a presensitized plate. In FIG. 1, C represents a carbon peak, Al is an aluminum peak, and O is an oxygen peak. Auger electron spectroscopy can be carried out after folding the presensitized plate about 180° just prior to analysis so as to create a fracture plane in the anodized layer, then securing the plate in a sample holder for an Auger electron spectrometer and inserting the plate into the spectrometer.

I_{c} (the carbon (KLL) Auger electron differential peak-to-peak intensity) and Iₐₗ (the aluminum (KLL) Auger electron differential peak-to-peak intensity) are determined from FIG. 1. C/Al is computed by letting the value of S_{c} (carbon (KLL) Auger electron relative sensitivity factor) be 0.076, letting the value of Sₐₗ (aluminum (KLL) Auger electron relative sensitivity factor) be 0.105, and substituting into formula (1) the I_{c} and Iₐₗ values determined above. In FIG. 1, C/Al is 0.76.

It is preferable to carry out Auger electron spectroscopy at a plurality of points (e.g., 5 points) on the fracture plane of the anodized layer, and determine the ratio C/Al as an average of the measurements obtained.

Typical Auger electron spectroscopy conditions are shown below.
Measurement apparatus: FE-type Auger electron spectrometer,
model SMART-200 (manufactured by Ulvac-Phi, Inc.)
Beam current: approx. 10 nA
Acceleration voltage: 10 kV
Electron beam diameter: focused
Chamber pressure: approx. 1×10⁻¹⁰ torr (approx. 1.33×10⁻⁸ Pa)
Detection range: 20 to 2,020 eV; 0 eV/step; 20 ms/step
Multiplier voltage: 2,250 V

In the practice of the invention, the C/Al ratio in the fracture plane of the anodized layer after the image recording layer has been provided on the support is preferably not more than 1.0, and more preferably not more than 0.8. By suppressing entry of the image recording layer into the micropores of the anodized layer so that the C/Al ratio is held to 1.0 or less, the presensitized plate of the invention can be provided with a particularly outstanding on-machine developability.

Lithographic Printing Method:

The lithographic printing method of the invention is a process in which the above-described presensitized plate of the invention is imagewise exposed with an infrared laser, printing ink and dampening water are supplied to the exposed plate, and printing is carried out.

No particular limitation is imposed on the infrared laser used in the invention, although solid lasers and semiconductor lasers which emit infrared light at a wavelength of 760 to 1200 nm are preferred. The infrared laser has an output of preferably at least 100 mW. To shorten the exposure time, the use of a multi-beam laser device is preferred.

The exposure time per pixel is preferably not more than 20 microseconds, and the exposure dose is preferably 10 to 300 mJ/cm².

In the lithographic printing method of the invention, as described above, the inventive presensitized plate is imagewise exposed with an infrared laser. An oil-based ink and an aqueous component are then supplied to the exposed plate, and printing is carried out without passing through a processing step.

Specific examples include processes in which the presensitized plate is exposed with an infrared laser, following which the plate is mounted on a printing press and printing is carried out without passing through a processing step; and processes in which the presensitized plate is mounted on a printing press, then exposed on the press with an infrared laser and subsequently printed without passing through a processing step.

When printing is carried out by imagewise exposure of the presensitized plate with an infrared laser followed by the supply of an aqueous component and an oil-based ink without passing through a processing step such as wet development, in exposed areas of the image recording layer, the image recording layer cured by exposure forms oil-based ink-receptive areas having an oleophilic surface. At the same time, in unexposed areas, the uncured image recording layer is dissolved or dispersed and removed by the aqueous component and/or oil-based ink supplied, uncovering the hydrophilic surface of the plate in those areas. Here, in the lithographic printing method of the invention, because the micropores in the anodized layer on the support for lithographic printing plate have been sealed, no oleophilic image recording layer remains on the revealed hydrophilic surface. Accordingly, on-machine development can easily be carried out.

As a result of such on-machine development, the aqueous component adheres to the now uncovered hydrophilic surfaces, the oil-based ink deposits on the exposed areas of the image recording layer, and printing begins. Either the aqueous component or the oil-based ink may be supplied first to the plate surface, although it is preferable to initially supply the oil-based ink so as to prevent the aqueous component from being contaminated by the image recording layer in unexposed areas of the plate. Dampening water and printing ink for conventional lithographic printing may be used as the aqueous component and the oil-based ink.

In this way, the presensitized plate is developed on an offset printing press, then used directly in this developed state to print a large number of impressions.

### EXAMPLES

Examples are given below by way of illustration, although the invention is not limited by these examples.

1. Production of Support for Lithographic Printing Plate

### Examples 1 to 40 , and

### Comparative Examples 1 to 5

The aluminum plate described below was consecutively subjected to the graining treatments shown in Table 1 (here, “graining treatment” is used in a broad sense that encompasses also alkali etching treatment and desmutting treatment), anodizing treatment, sealing treatment and hydrophilizing treatment, in this order, thereby giving a support for a lithographic printing plate. In Table 1, a dash (“-”) indicates that the particular surface treatment in question was not carried out.

Aluminum Plate:

A melt was prepared by using an aluminum alloy composed of 0.07 wt % silicon, 0.27 wt % iron, 0.025 wt % copper, 0.001 wt % manganese, 0.000 wt % magnesium, 0.001 wt % chromium, 0.003 wt % zinc and 0.020 wt % titanium, with the balance being aluminum and inadvertent impurities. The melt was subjected to molten metal treatment and filtration, then was cast into a 500 mm thick, 1,200 mm wide ingot by a direct chill casting process. The ingot was faced, removing an average of 10 mm of material from the surface. The faced ingot was then soaked and held at 550° C. for about 5 hours. When the temperature had dropped to 400° C., the ingot was hot-rolled to a thickness of 2.7 mm. In addition, the resulting plate was heat-treated at 500° C. using a continuous annealing furnace, then cold-rolled to a final plate thickness of 0.24 mm. The plate was trimmed to a width of 1,030 mm, giving an aluminum plate of JIS 1050 aluminum alloy.

Graining Treatment:

Graining Treatment Al:

Graining Treatment Al consisted of consecutively carrying out the following surface treatments (a) to (i) on the aluminum plate. Following each treatment and rinsing with water, fluid was drained from the sheet with nip rollers.

Surface treatments (a) to (i) are each described below.

(a) Mechanical Graining Treatment

Using an apparatus like that shown schematically in FIG. 4, mechanical graining treatment was carried out with a rotating roller-type nylon brush while feeding an abrasive slurry consisting of a suspension (specific gravity, 1.13) of abrasive compound and water to the surface of the aluminum plate with a spray line. FIG. 4 shows an aluminum plate 1, roller-type brushes 2 and 4, an abrasive slurry 3, and support rollers 5, 6, 7 and 8. The abrasive compound was pumice that had been ground, then classified to an average particle size of 30 μm.

The nylon brush was a No. 3 brush that was made of nylon 6/10 and had a bristle length of 50 mm and a bristle diameter of 0.30 mm. The nylon brushes were 300 mm diameter stainless steel cylinders in which holes had been formed and bristles densely set. The brush roller used three nylon brushes and also had two support rollers (200 mm diameter) provided below the brush and spaced 300 mm apart. The brush roller controlled the load of the driving motor that rotates the nylon brush relative to the load before the brush is pushed against the aluminum plate, and pushed the brush against the aluminum plate such as to give the plate after graining an average calculated roughness (Ra) of 0.45 to 0.55 μm. The direction of brush rotation was the same as the direction of movement by the aluminum plate. The brush was rotated at a speed of 200 rpm.

The aluminum plate was then rinsed by spraying it with water.

(b) Alkali Etching Treatment

An aqueous solution having a NaOH concentration of 27 wt %, an aluminum ion concentration of 6.5 wt %, and a temperature of 70° C. was sprayed onto the aluminum plate, thereby carrying out alkali etching treatment. The loss of weight from dissolution by the aluminum plate was 10 g/m². The aluminum plate was then rinsed by spraying it with water.

(c) Desmutting Treatment

Desmutting treatment was carried out by spraying the aluminum plate with an aqueous nitric acid solution having a liquid temperature of 30° C. for 2 seconds, after which the plate was rinsed by spraying it with water. Overflow wastewater from the subsequently described (d) electrochemical graining treatment step carried out in an aqueous nitric acid solution with an alternating current was used as the aqueous nitric acid solution (the liquid composition was the same as that described below in (d)). The aluminum plate was then rinsed by spraying it with water.

(d) Electrochemical Graining Treatment with-Alternating Current in Aqueous Nitric Acid Solution

Electrochemical graining treatment was carried out continuously using a 60 Hz alternating voltage. Use was made of a liquid electrolyte (liquid temperature, 35° C.) prepared by dissolving aluminum nitrate in a 10 g/L aqueous solution of nitric acid and setting the aluminum ion concentration to 4.5 g/L. The AC power supply waveform, shown in FIG. 2, had a time Tp until the current value reached a peak from zero of 0.8 msec and a duty ratio (ta/T) of 0.5. A carbon electrode was used as the counterelectrode. Ferrite was used as the auxiliary anode. Two electrolytic cells like that shown in FIG. 3 were used.

In electrochemical graining treatment, the current density (peak value of current) was set at 50 A/dm². The ratio between the total amount of electricity during the reaction when the aluminum plate served as the anode and the total amount of electricity during the reaction when the aluminum plate served as the cathode was 0.95. The total amount of electricity when the aluminum plate served as the anode was 195 C/dm². Five percent of the current from the power supply was diverted to the auxiliary anode.

The aluminum plate was then rinsed by spraying it with water.

(e) Alkali Etching Treatment

An aqueous solution having a NaOH concentration of 27 wt %, an aluminum ion concentration of 5.5 wt %, and a temperature of 65° C. was sprayed onto the aluminum plate, thereby carrying out alkali etching treatment. The loss of weight from dissolution by the aluminum plate was 3.5 g/m². The aluminum plate was then rinsed by spraying it with water.

(f) Desmutting Treatment

Desmutting treatment was carried out by spraying the aluminum plate with an aqueous solution of sulfuric acid (concentration, 300 g/L) containing 5 g/L of aluminum ions and having a temperature of 35° C. for 10 seconds. The aluminum plate was then rinsed by spraying it with water.

(g) Electrochemical Graining Treatment with Alternating Current in Aqueous Hydrochloric Acid Solution

Electrochemical graining treatment was carried out continuously using a 60 Hz alternating voltage. Use was made of a liquid electrolyte (liquid temperature, 35° C.) prepared by dissolving aluminum chloride in a 5 g/L aqueous solution of hydrochloric acid and setting the aluminum ion concentration to 4.5 g/L. The AC power supply waveform, shown in FIG. 2, had a time Tp until the current value reached a peak from zero of 0.8 msec and a duty ratio (ta/T) of 0.5. A carbon electrode was used as the counterelectrode. Ferrite was used as the auxiliary anode. One electrolytic cell like that shown in FIG. 3 was used.

In electrochemical graining treatment, the current density (peak value of current) was set at 50 A/dm². The ratio between the total amount of electricity during the reaction when the aluminum plate served as the anode and the total amount of electricity during the reaction when the aluminum plate served as the cathode was 0.95. The total amount of electricity when the aluminum plate served as the anode was 60 C/dm². Five percent of the current from the power supply was diverted to the auxiliary anode. The aluminum plate was then rinsed by spraying it with water.

(h) Alkali Etching Treatment

An aqueous solution having a NaOH concentration of 5 wt %, an aluminum ion concentration of 0.5 wt %, and a temperature of 48° C. was sprayed onto the aluminum plate, thereby carrying out alkali etching treatment. The loss of weight from dissolution by the aluminum plate was 0.2 g/m². The aluminum plate was then rinsed by spraying it with water.

(i) Desmutting Treatment

Desmutting treatment was carried out by spraying the aluminum plate with an aqueous solution of sulfuric acid (concentration, 300 g/L) containing 1 g/L of aluminum ions and having a temperature of 60° C. for 5 seconds. The aluminum plate was then rinsed by spraying it with water.

Graining Treatment A2:

Aside from setting the temperature of the aqueous solution in step (e) to 40° C., having the loss of weight from dissolution by the aluminum plate in the same step be 0.7 g/m², and not carrying out above steps (g) to (i), Graining Treatment A2 was carried out in the same way as Graining Treatment A1.

Graining Treatment A3:

Aside from not carrying out step (a), Graining Treatment A3 was carried out in the same way as Graining Treatment A1.

Graining Treatment A4:

Aside from not carrying out step (a) and steps (g) to (i), having the total amount of electricity when the aluminum plate serves as the anode in step (d) be 270 C/dm², and having the temperature of the aqueous solution in step (e) be 30° C. and the loss of weight-from dissolution by the aluminum plate in the same step be 0.3 g/m², Graining Treatment A4 was carried out in the same way as Graining Treatment A1.

Graining Treatment A5:

Aside from not carrying out steps (a) to (d), having the total amount of electricity when the aluminum sheet serves as the anode in step (g) be 500 C/dm², and having the temperature of the aqueous solution in step (h) be 55° C. and the loss of weight from dissolution by the aluminum plate in the same step be 0.8 g/m², Graining Treatment A5 was carried out in the same way as Graining Treatment A1.

Anodizing Treatment:

Anodizing Treatment B1:

Anodizing Treatment B1 was carried out using an anodizing system that operates by means of direct-current electrolysis, thereby giving a support for a lithographic printing plate. Sulfuric acid was used as the electrolytic solutions supplied to a first electrolysis section and a second electrolysis section. Both electrolytic solutions had a sulfuric acid concentration of 170 g/L, contained 0.5 g/L of aluminum ions, and had a temperature of 40° C. The current density (peak value of current) was 20 A/dm².

The aluminum plate was then rinsed by spraying it with water. The final oxide film had a weight of 2.5 g/m².

Anodizing Treatment B2:

Aside from setting the weight of the oxide film to 4.0 g/m², Anodizing Treatment B2 was carried out in the same way as Anodizing Treatment B1.

Anodizing Treatment B3:

Aside from setting the weight of the oxide film to 1.0 g/m², Anodizing Treatment B3 was carried out in the same way as Anodizing Treatment B1.

Anodizing Treatment B4:

Aside from setting the electrolytic solutions to a sulfuric acid concentration of 100 g/L, an aluminum ion content of 0.5 g/L and a temperature of 50° C., and setting the current density (peak value of current) to 30 A/dm², Anodizing Treatment B4 was carried out in the same way as Anodizing Treatment B1.

Sealing Treatment:

Sealing treatment was carried out. This consisted of the subsequently described sealing treatment with steam, sealing treatment with hot water, or sealing treatment with an aqueous solution containing at least an inorganic fluorine compound.

Sealing Treatment with Steam:

Sealing treatment with steam was carried out by bringing the aluminum plate on whose surface an anodized layer had been formed by anodizing treatment as described above into contact with steam at a pressure within a range of atmospheric pressure to (atmospheric pressure+30 mmAq) (1.013×10⁵ to 1.016×10⁵ Pa), and at the temperature and for the length of time indicated in Table 1.

Sealing Treatment with Hot Water:

Sealing treatment with hot water was carried out by dipping the aluminum plate on whose surface an anodized layer had been formed by anodizing treatment as described above in pure water at the temperature and for the length of time indicated in Table 1.

Sealing Treatment with an Inorganic Fluorine Compound-Containing Aqueous Solution:

Sealing treatment with an aqueous solution containing at least an inorganic fluorine compound was carried out by dipping the aluminum plate on whose surface an anodized layer had been formed by anodizing treatment as described above in an aqueous solution containing the compounds indicated in Table 1. Table 1 also indicates the concentrations of the compounds in the solution, the temperature of the solution, and the length of time the plate was dipped in the solution. The aluminum plate was then rinsed by spraying it with water.

In Table 1, “Na₂ZrF₆ 0.1%+NaH₂PO₄ 1%” indicates, for example, that the aqueous solution contains 0.1 wt % of Na₂ZrF₆ and 1 wt % of NaH₂PO₄.

Hydrophilizing Treatment:

Hydrophilizing Treatment D1:

Hydrophilizing treatment D1 was carried out by dipping the aluminum plate for 10 seconds in an aqueous solution of No. 3 sodium silicate having a concentration of 1.0 wt %, a temperature of 30° C. and a pH of 11.2. The aluminum plate was then rinsed by spraying it with water.

Hydrophilizing Treatment D2:

Aside from setting the concentration of the aqueous solution to 2.5 wt % and the pH at 11.5, Hydrophilizing Treatment D2 was carried out in the same way as Hydrophilizing Treatment D1.

Hydrophilizing Treatment D3:

Aside from setting the pH of the aqueous solution to 13.2, Hydrophilizing Treatment D3 was carried out in the same way as Hydrophilizing Treatment D1.

Hydrophilizing Treatment D4:

Aside from setting the concentration of the aqueous solution to 3.0 wt %, the temperature to 60° C. and the pH to 11.5, Hydrophilizing Treatment D4 was carried out in the same way as Hydrophilizing Treatment D1.

Hydrophilizing Treatment D5:

Aside from setting the temperature of the aqueous solution to 20° C. and the dipping time to 20 seconds, Hydrophilizing Treatment D5 was carried out in the same way as Hydrophilizing Treatment D2.

Hydrophilizing Treatment D6:

Aside from setting the temperature of the aqueous solution to 60° C. and the dipping time to 3 seconds, Hydrophilizing Treatment D6 was carried out in the same way as Hydrophilizing Treatment D3.

Hydrophilizing Treatment D7:

Hydrophilizing treatment D7 was carried out by dipping the aluminum plate for 10 seconds in an aqueous solution of polyvinyl phosphonic acid having a concentration of 0.5 wt % and a temperature of 60° C. The aluminum plate was then rinsed by spraying it with water.

2. Fabrication of Presensitized Plate

Presensitized plates were fabricated by bar-coating an image recording layer-forming coating fluid of the composition indicated below onto each of the supports for lithographic printing plate obtained above, then drying in an oven at 70° C. for 60 seconds to form an image recording layer having a dry coating weight of 0.8 g/m².

Composition of Image Recording Layer-Forming Coating Liquid:

| | |
|---|---|
| Water | 55 g |
| Propylene glycol monomethyl ether | 30 g |
| Methanol | 5 g |
| Microcapsule liquid described below | 5 g (solids) |

| | |
|---|---|
| Ethoxylated trimethylolpropane triacrylate | 0.2 g |
| (SR9035, available from Nippon Kayaku Co., | |
| Ltd.; moles of ethylene oxide added, | |
| 15; molecular weight, 1,000) | |
| Polymerization initiator (OS-7 above) | 0.5 g |
| Infrared Absorber (1) of the following formula | 0.15 g |

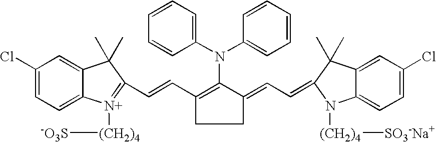

| | |
|---|---|
| Ethylene glycol | 0.1 g |
| Fluorocarbon surfactant (Megafac F-171, available from | 0.1 g |
| Dainippon Ink & Chemicals) | |

Microcapsule Liquid:

An oil phase component was prepared by dissolving 10 g of trimethylolpropane-xylylene diisocyanate adduct (Takenate D-110N, available from Mitsui Takeda Chemicals, Inc.), 3.15 g of pentaerythritol triacrylate (SR444, available from Nippon Kayaku Co., Ltd.), 0.35 g of Infrared Absorber (2) of the following formula 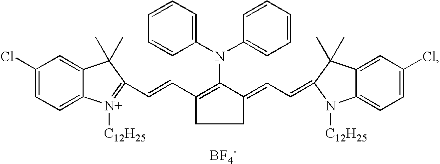
1 g of 3-(N,N-diethylamino)-6-methyl-7-anilinofluoran (ODB, available from Yamamoto Chemicals, Inc.) and 0.1 g of surfactant (Pionin A-41C, available from Takemoto Oil & Fat Co., Ltd.) in 17 g of ethyl acetate. An aqueous phase component was obtained by preparing 40 g of an aqueous solution containing 4 wt % of polyvinyl alcohol (PVA-205, available from Kuraray Co., Ltd.). The oil phase component and aqueous phase component were mixed and emulsified using a homogenizer at 12,000 rpm for 10 minutes. The resulting emulsion was added to 25 g of distilled water, following which the mixture was stirred, first at room temperature for 30 minutes, then at 40° C. for 3 hours. The mixture was then diluted with distilled water so as to form a microcapsule liquid having a solids concentration of 20 wt %. The microcapsules had an average particle size of 0.3 μm.
3. Measurement of Carbon-to-Aluminum Atomic Ratio (C/Al) in Fracture Plane of Anodized Layer after Image Recording Layer Formation

Measurement of the carbon-to-aluminum atomic ratio (C/Al) in the fracture plane was carried out as follows for the presensitized plates obtained as described above.

A fracture plane in the anodized layer was created by folding the presensitized plate about 180° just prior to analysis. The plate was then secured in a sample holder for an Auger electron spectrometer and inserted into the spectrometer, following which Auger electron spectroscopy was carried out.

The I_{c} and Iₐₗ values were determined from the resulting chart. The ratio C/Al was computed from the formula
C/Al=(I_{c}/S_{c})/(Iₐₗ/Sₐₗ) (1)
by letting the value of S_{c} be 0.076, letting the value of Sₐₗ be 0.105, and substituting the measured I_{c} and Iₐₗ values into the formula. The results are shown in Table 1.

Auger electron spectroscopic analysis was carried out at five points within the fracture plane of the anodized layer and positioned about 0.2 μm from the boundary between the heat-sensitive layer and the anodized layer. The C/Al ratio was determined as the average of the resulting measurements.

The conditions for Auger Electron spectroscopic analysis were as follows.
Measurement apparatus: FE-type Auger electron spectrometer, model SMART-200 (manufactured by Ulvac-Phi, Inc.)
Beam current: approx. 10 nA
Acceleration voltage: 10 kV
Electron beam diameter: focused
Chamber pressure: approx. 1×10⁻¹⁰ torr (approx. 1.33×l0⁻⁸ Pa)
Detection range: 20 to 2,020 eV; 0 eV/step; 20 ms/step
Multiplier voltage: 2,250 V
   4. Exposure and Printing

Each of the resulting presensitized plates was exposed using a Trendsetter 3244 VX (Creo Inc.) equipped with a water-cooled 40 W infrared semiconductor laser at an output of 9 W, an external drum speed of 210 rpm, and a resolution of 2,400 dpi.

The exposed presensitized plate was mounted on the plate cylinder of a SOR-M printing press (Heidelberger Druckmaschinen AG) without first being subjected to development. Next, dampening water (IF102 (an etchant available from Fuji Photo Film Co., Ltd.)/water=4/96 by volume) and TRANS-G (N) India ink (Dainippon Ink and Chemicals, Inc.) were supplied to the plate, following which printing was carried out on printing paper at a press speed of 6,000 impressions per hour.

5. Evaluation of Presensitized Plate

(1) Sensitivity

The plate surface energy was varied during exposure by varying the external drum speed. After printing, the sensitivity was evaluated from the minimum exposure dose capable of image formation. The results are shown in Table 1.

(2) Removability (On-Machine Developability)

The image recording layer removability (on-machine developability) was evaluated from the number of sheets of printing paper required, after printing had begun, to completely remove unexposed areas of the image recording layer on press and achieve a state in which-ink is not transferred from these areas to the printing paper. The results are shown in Table 1.

(3) Press Life

After the completion of on-machine development, printing was continued further. As the number of impressions increased, the image recording layer gradually wore down and ink receptivity declined, leading to a decrease in the ink density on the printing paper. The press life was rated as the number of impressions that could be printed before the ink density (reflection density) fell to a value 0.1 lower than the ink density at the start of printing. The results are shown in Table 1.

(4) Scumming Resistance

After the on-machine developability (2) was evaluated, the printing plate was left to stand for one hour, following which printing was carried out once again. The scumming resistance was rated as the number of copies printed until normal impressions could be obtained in which ink adhered to exposed areas of the plate and did not adhere to unexposed areas. The results are shown in Table 1.

(5) Chemical Resistance

The same procedure was carried-out as when evaluating the press life (3) above, except that, every 5,000 impressions during printing, Multicleaner (available from Fuji Photo Film Co., Ltd.) was applied to the surface of the image recording layer for 1 minute, then wiped off with water. The chemical resistance was rated as the number of impressions that could be printed before the ink density (reflection density) fell to a value 0.1 lower than at the start of printing. The results are shown in Table 1.

As is apparent from Table 1, the presensitized plates of the invention (Examples 1 to 40) have an excellent removability (on-machine developability) and press life. In addition, they also have an excellent sensitivity, scumming resistance and chemical resistance.

By contrast, presensitized plates lacking an anodized layer (Comparative Examples 1 and 4) exhibit an inferior removability, press life and others. Presensitized plates that have not been performed sealing treatment (Comparative Examples 2, 3 and 5) have an excellent press life and sensitivity, but have a poor removability and other inferior characteristics.

TABLE 1-1

| | | | | | | Hydro- | | | Press life | Chemical | Remova- | Scum- |
|---|---|---|---|---|---|---|---|---|---|---|---|---|
| | | | Sealing treatment | | | philizing | | Sensi- | (1000's | resistance | bility | ming |
| | Graining | Anodizing | | Temp. | Time | treat- | | tivty | of im- | (1000's of | (number of | resis- |
| | treatment | treatment | Method | (° C.) | (sec) | ment | C/Al | (mJ/cm²) | pressions) | impressions) | impressions) | tance |
| EX 1 | A1 | B1 | steam | 100 | 15 | D1 | 0.5 | 60 | 50 | 40 | 50 | 30 |
| EX 2 | A2 | B1 | steam | 100 | 15 | D1 | 0.5 | 60 | 40 | 30 | 50 | 30 |
| EX 3 | A3 | B1 | steam | 100 | 15 | D1 | 0.4 | 50 | 55 | 45 | 50 | 30 |
| EX 4 | A4 | B1 | steam | 100 | 15 | D1 | 0.4 | 50 | 50 | 40 | 50 | 30 |
| EX 5 | A5 | B1 | steam | 100 | 15 | D1 | 0.4 | 60 | 40 | 35 | 50 | 30 |
| EX 6 | A4 | B2 | steam | 100 | 15 | D1 | 0.8 | 60 | 50 | 45 | 60 | 35 |
| EX 7 | A1 | B1 | steam | 100 | 10 | D1 | 0.7 | 60 | 50 | 40 | 55 | 35 |
| EX 8 | A2 | B1 | steam | 100 | 20 | D1 | 0.3 | 50 | 40 | 30 | 40 | 25 |
| EX 9 | A3 | B1 | steam | 80 | 100 | D1 | 0.9 | 70 | 50 | 40 | 70 | 40 |
| EX 10 | A4 | B1 | steam | 90 | 60 | D1 | 0.9 | 70 | 50 | 40 | 75 | 45 |
| EX 11 | A5 | B1 | steam | 100 | 1 | D1 | 0.9 | 70 | 40 | 35 | 70 | 40 |
| EX 12 | A3 | B2 | hot water | 100 | 10 | D1 | 0.8 | 60 | 50 | 35 | 60 | 35 |
| EX 13 | A4 | B2 | hot water | 100 | 10 | D1 | 0.8 | 60 | 50 | 40 | 60 | 35 |
| EX 14 | A3 | B1 | hot water | 100 | 20 | D1 | 0.4 | 50 | 40 | 40 | 50 | 30 |
| EX 15 | A3 | B2 | hot water | 80 | 100 | D5 | 0.8 | 60 | 40 | 30 | 60 | 30 |
| EX 16 | A5 | B3 | hot water | 90 | 60 | D1 | 0.9 | 70 | 40 | 30 | 70 | 40 |
| EX 17 | A3 | B4 | hot water | 100 | 1 | D6 | 0.9 | 70 | 40 | 30 | 70 | 40 |
| EX 18 | A3 | B1 | Na₂ZrF₆ 0.1% + | 60 | 10 | D1 | 0.4 | 50 | 50 | 40 | 60 | 35 |
| | | | NaH₂PO₄ 1% | | | | | | | | | |
| EX 19 | A5 | B1 | Na₂ZrF₆ 0.1% + | 60 | 10 | D2 | 0.4 | 50 | 40 | 35 | 40 | 25 |
| | | | NaH₂PO₄ 1% | | | | | | | | | |
| EX 20 | A3 | B1 | Na₂ZrF₆ 0.1% | 60 | 10 | D3 | 0.4 | 50 | 50 | 35 | 40 | 30 |
| | | | NaH₂PO₄ 1% | | | | | | | | | |
| EX 21 | A4 | B1 | Na₂ZrF₆ 0.1% + | 60 | 10 | D1 | 0.4 | 50 | 50 | 35 | 40 | 30 |
| | | | NaH₂PO₄ 1% | | | | | | | | | |
| EX 22 | A1 | B4 | Na₂ZrF₆ 0.1% + | 60 | 10 | D4 | 0.3 | 60 | 50 | 40 | 40 | 25 |
| | | | NaH₂PO₄ 1% | | | | | | | | | |
| EX 23 | A1 | B1 | Na₂ZrF₆ 0.1% + | 60 | 10 | D1 | 0.4 | 60 | 50 | 40 | 50 | 30 |
| | | | NaH₂FO₄ 1% | | | | | | | | | |
| EX 24 | A1 | B3 | Na₂ZrF₆ 0.1% + | 60 | 10 | D4 | 0.4 | 60 | 50 | 40 | 80 | 25 |
| | | | NaH₂PO₄ 1% | | | | | | | | | |
| EX 25 | A1 | B1 | Na₂ZrF₆ 0.1% + | 100 | 5 | D1 | 0.2 | 50 | 50 | 40 | 50 | 30 |
| | | | NaH₂PO₄ 1% | | | | | | | | | |

TABLE 1-2

| | | | | | | Hydro- | | | Press life | Chemical | Remova- | Scum- |
|---|---|---|---|---|---|---|---|---|---|---|---|---|
| | | | Sealing treatment | | | philizing | | Sensi- | (1000's | resistance | bility | ming |
| | Graining | Anodizing | | Temp. | Time | treat- | | tivty | of im- | (1000's of | (number of | resis- |
| | treatment | treatment | Method | (° C.) | (sec) | ment | C/Al | (mJ/cm²) | pressions) | impressions) | impressions) | tance |
| EX 26 | A2 | B1 | Na₂ZrF₆ 0.1% + | 100 | 1 | D1 | 0.9 | 70 | 40 | 30 | 70 | 45 |
| | | | + NaH₂PO₄ 3% | | | | | | | | | |
| EX 27 | A3 | B1 | Na₂ZrF₆ 0.05% + | 80 | 10 | D1 | 0.2 | 50 | 55 | 45 | 60 | 40 |
| | | | + NaH₂PO₄ 1% | | | | | | | | | |
| EX 28 | A4 | B1 | Na₂ZrF₆ 0.01% + | 60 | 10 | D1 | 0.6 | 60 | 50 | 40 | 70 | 45 |
| | | | + NaH₂PO₄ 1% | | | | | | | | | |
| EX 29 | A5 | B1 | Na₂ZrF₆ 1% + | 80 | 10 | D1 | 0.3 | 50 | 40 | 40 | 50 | 30 |
| | | | NaH₂PO₄ 1% | | | | | | | | | |
| EX 30 | A4 | B2 | Na₂ZrF₆ 1% + | 80 | 10 | D1 | 0.3 | 50 | 50 | 40 | 50 | 30 |
| | | | NaH₂PO₄ 3% | | | | | | | | | |
| EX 31 | A3 | B1 | Na₂ZrF₆ 1% + | 80 | 10 | D1 | 0.4 | 50 | 40 | 40 | 60 | 35 |
| | | | NaH_{2PO}₄ 20% | | | | | | | | | |
| EX 32 | A3 | B1 | Na₂ZrF₆ 0.1% + | 20 | 100 | D2 | 0.7 | 60 | 50 | 40 | 60 | 35 |
| | | | + NaH₂PO₄ 1% | | | | | | | | | |
| EX 33 | A5 | B1 | Na₂ZrF₆ 0.1% + | 60 | 50 | D1 | 0.4 | 50 | 40 | 40 | 40 | 30 |
| | | | + NaH₂PO₄ 10% | | | | | | | | | |
| EX 34 | A1 | B1 | Na₂ZrF₆ 0.1% | 80 | 10 | D7 | 0.3 | 50 | 50 | 40 | 40 | 30 |
| | | | + NaH₂PO₄ 1% | | | | | | | | | |
| EX 35 | A1 | B1 | Na₂ZrF₆ 0.5% + | 60 | 50 | D1 | 0.3 | 50 | 50 | 40 | 60 | 35 |
| | | | + NaH₂PO₄ | | | | | | | | | |
| | | | 0.01% | | | | | | | | | |
| EX 36 | A1 | B3 | Na₂ZrF₆ 0.1% + | 80 | 50 | D1 | 0.2 | 50 | 50 | 40 | 40 | 30 |
| | | | + NaH₂PO₄ 1% | | | | | | | | | |
| EX 37 | A1 | B4 | Na₂ZrF₆ 0.1% + | 95 | 10 | D1 | 0.1 | 50 | 50 | 40 | 40 | 30 |
| | | | + KH₂PO₄ 1% | | | | | | | | | |
| EX 38 | A1 | B1 | Na₂ZrP₆ 0.1% + | 95 | 10 | D1 | 0.1 | 50 | 50 | 40 | 40 | 30 |
| | | | + NaH₂PO₄ 1% | | | | | | | | | |
| EX 39 | A1 | B1 | H₂ZrF₆ 0.1% + | 60 | 10 | D1 | 0.4 | 50 | 50 | 40 | 40 | 30 |
| | | | NaH₂PO₄ 1% | | | | | | | | | |
| EX 40 | A1 | B1 | K₂TiF₆ 0.1% + | 60 | 10 | D1 | 0.4 | 50 | 50 | 40 | 40 | 30 |
| | | | NaH₂PO₄ 1% | | | | | | | | | |
| CE 1 | A4 | — | steam | 100 | 15 | D1 | — | 200 | 5 | 3 | 300 | 120 |
| CE 2 | A5 | B1 | — | — | — | D1 | 1.1 | 70 | 40 | 15 | 1,000 | 120 |
| CE 3 | A4 | B1 | — | — | — | D1 | 1.2 | 80 | 50 | 10 | 1,000 | 115 |
| CE 4 | A4 | — | Na₂ZrF₆ 0.1% + | 60 | 50 | D1 | — | 200 | 5 | 2 | 200 | 90 |
| | | | NaH₂PO₄ 20% | | | | | | | | | |
| CE 5 | A1 | B1 | — | — | — | D1 | 1.1 | 60 | 50 | 10 | 1,000 | 130 |

1. A presensitized plate, comprising:
a support for a lithographic printing plate obtainable by forming on an aluminum plate at least an anodized layer, then performing sealing treatment; and
an image recording layer which is provided on the support, includes an infrared absorber (A), a polymerization initiator (B), and a polymerizable compound (C), and can be removed with printing ink and/or dampening water.

2. The presensitized plate according to claim 1, wherein the sealing treatment is carried out with an aqueous solution containing an inorganic fluorine compound.

3. The presensitized plate according to claim 2, wherein the inorganic fluorine compound has a concentration in the aqueous solution of 0.01 to 1 wt %.

4. The presensitized plate according to claim 2, wherein the aqueous solution contains also a phosphate compound.

5. The presensitized plate according to claim 4, wherein the aqueous solution contains as the inorganic fluorine compound at least sodium hexafluorozirconate and contains as the phosphate compound at least sodium dihydrogenphosphate.

6. The presensitized plate according to claim 4, wherein the phosphate compound has a concentration in the aqueous solution of 0.01 to 20 wt %.

7. The presensitized plate according to claim 2, wherein the sealing treatment is carried out at a temperature in the range of 20 to 100° C.

8. The presensitized plate according to claim 2, wherein the sealing treatment is carried out for a period of from 1 to 100 seconds.

9. The presensitized plate according to claim 1, wherein the sealing treatment is carried out with steam.

10. The presensitized plate according to claim 9, wherein the sealing treatment is carried out at a temperature in the range of 80 to 105° C.

11. The presensitized plate according to claim 1, wherein the sealing treatment is carried out with hot water.

12. The presensitized plate according to claim 11, wherein the sealing treatment is carried out at a temperature in the range of 80 to 100° C.

13. The presensitized plate according to claim 9, wherein the sealing treatment is carried out for a period of from 1 to 100 seconds.

14. The presensitized plate of claim 1, wherein the anodized layer after the image recording layer has been provided on the support has a fracture plane in which the atomic ratio of carbon to aluminum (C/Al) expressed by formula (1) below is at most 1.0;
C/Al=(I_{c}/S_{c})/(Iₐₗ/Sₐₗ) (1),
wherein
I_{c} is the carbon (KLL) Auger electron differential peak-to-peak intensity,
Iₐₗ is the aluminum (KLL) Auger electron differential peak-to-peak intensity,
S_{c} is the carbon (KLL) Auger electron relative sensitivity factor, and
Sₐₗ is the aluminum (KLL) Auger electron relative sensitivity factor.

15. The presensitized plate according to claim 1, wherein the support is obtainable by performing hydrophilizing treatment after the sealing treatment.

16. The presensitized plate according to claim 15, wherein the hydrophilizing treatment is carried out with an aqueous solution containing an alkali metal silicate.

17. The presensitized plate according to claim 15, wherein the hydrophilizing treatment is carried out at a temperature in the range of 20 to 100° C.

18. The presensitized plate according to claim 1, wherein at least some of the infrared absorber (A), polymerization initiator (B) and polymerizable compound (C) is microencapsulated.

19. A lithographic printing method which includes the steps of imagewise exposing the presensitized plate according to claim 1 with an infrared laser, supplying printing ink and dampening water to the exposed plate to print.
